(19) United States
(12) Patent Application Publication
(10) Pub. No.: US 2026/0281912 A1
(43) Pub. Date: Sep. 17, 2026

(54) COMMUNICATION CONTROL APPARATUS AND COMMUNICATION CONTROL METHOD

(71) Applicant: Sony Group Corporation, Tokyo (JP)

(72) Inventors: Hiroto KURIKI, Tokyo (JP); Sho FURUICHI, Tokyo (JP)

(73) Assignee: Sony Group Corporation, Tokyo (JP)

(21) Appl. No.: 18/875,739

(22) PCT Filed: Jul. 25, 2023
(86) PCT No.: PCT/JP2023/027206

§ 371 Date: Dec. 17, 2024

(30) Foreign Application Priority Data
Aug. 1, 2022 (JP) 2022-122950

(51) Int. Cl. H04W 52/24

(52) U.S. Cl. CPC H04W 52/243

(57) ABSTRACT

A communication control apparatus according to the present disclosure includes a processor that acquires information indicating a priority relationship in interference protection between a first communication apparatus and a second communication apparatus that each transmit radio waves, that determines an amount of a reduction in a transmission power of the first communication apparatus on the basis of the information indicating the priority relationship and an allowed interference power of the second communication apparatus, and that determines an allowed transmission power of the first communication apparatus on the basis of the reduction amount.

### TECHNICAL FIELD

The present disclosure relates to a communication control apparatus and a communication control method.

### BACKGROUND ART

The exhaustion of radio resources (frequencies/spectra) that can be assigned to wireless systems has become an issue due to an increase in a wireless environment in which various wireless systems coexist, and due to wirelessly provided content becoming richer. Thus, “dynamic spectrum access (DSA)” is rapidly gaining attention as a method for obtaining necessary radio resources, where “dynamic spectrum access (DSA)” utilizes temporal and spatial vacancies (white spaces) in a frequency band assigned to a specific wireless system.

In the United States, a DSA system called Citizens Broadband Radio Service (CBRS) has been introduced and commercially deployed in the 3550-to-3700-MHz band. Non-Patent Literature 6 discloses that the assignment of a priority access license (PAL) channel in the CBRS goes up for spectrum auction on a county-by-county basis in 10 MHz channels. A telecommunications operator having made a successful bid is allowed to freely use the channel as a PAL for a certain period of time in the county. Further, Non-Patent Literature 5 (47 C.F.R Part 96) discloses that a telecommunications operator having made a successful bid for a PAL channel at spectrum auction is also allowed to lease the right to use the channel to another telecommunications operator (PAL leasing). A Spectrum Access System (SAS) administrator can carry out a procedure for filing an application for the PAL leasing with the Federal Communications Commissions (FCC).

### CITATION LIST

### Non-Patent Literature

Non-Patent Literature 1: WINNF-TS-0112-V1.9.1 “Requirements for Commercial Operation in the U.S. 3550-3700 MHz Citizens Broadband Radio Service Band” [available at https://cbrs.wirelessinnovation.org/release-1-of-the-baseline-standard-specifications]
Non-Patent Literature 2: WINNF-SSC-0008-V1. 3.0, “Spectrum Sharing Committee Policy and Procedure Coordinated Periodic Activities Policy”
Non-Patent Literature 3: WINNF-TS-0061-V1.5.1 Test and Certification for Citizens Broadband Radio Service (CBRS); Conformance and Performance Test Technical Specification; SAS as Unit Under Test (UUT) [available at https://cbrs.wirelessinnovation.org/release-1-of-the-baseline-standard-specifications]
Non-Patent Literature 4: WINNF-TS-0016-V1.2.4 Signaling Protocols and Procedures for Citizens Broadband Radio Service (CBRS): Spectrum Access System (SAS)—Citizens Broadband Radio Service Device (CBSD) Interface Technical Specification [available at https://cbrs.wirelessinnovation.org/release-1-of-the-baseline-standard-specifications]
Non-Patent Literature 5: Electronic Code of Federal Regulations, Title 47, Chapter I, Subchapter D, Part 96 [available at https://ecfr.federalregister.gov/current/title-47/chapter-I/subchapter-D/part-96]
Non-Patent Literature 6:3.5 GHZ Band Overview [available at https://www.fcc.gov/35-ghz-band-overview]
Non-Patent Literature 7: “940660 D02 CPE-CBSD Handshake Procedures v02”, Federal Communications Commission Office of Engineering and Technology Laboratory Division, October 2019, available at https://apps.fcc.gov/oetcf/kdb/forms/FTSSearchResultPage.cfm?id=229297&switch=P
Non-Patent Literature 8: WINNF-TS-0061-V1.5.1 Test and Certification for Citizens Broadband Radio Service (CBRS); Conformance and Performance Test Technical Specification; SAS as Unit Under Test (UUT) [available at https://cbrs.wirelessinnovation.org/release-1-of-the-baseline-standard-specifications]
Non-Patent Literature 9: WINNF-TS-0016-V1.2.4 Signaling Protocols and Procedures for Citizens Broadband Radio Service (CBRS): Spectrum Access System (SAS)—Citizens Broadband Radio Service Device (CBSD) Interface Technical Specification [available at https://cbrs.wirelessinnovation.org/release-1-of-the-baseline-standard-specifications]
Non-Patent Literature 10: WINNF-TS-1001 V1. 4. 0, “CBRS Operational and Functional Requirements (Release 2)” [available at https://cbrs.wirelessinnovation.org/enhancements-to-baseline-specifications]

### DISCLOSURE OF INVENTION

### Technical Problem

When a license is leased to a lessee and the leasing of the license is registered with an SAS in accordance with a specified registration procedure, the SAS calculates a PAL protection area (PPA) for a CBSD of the lessee having a PAL, as it does for the lessor. Then, an iterative allocation process (IAP) performed in cooperative periodic activities among SASs (CPAS) is performed to protect the CBSD of the lessee from being interfered with by CBSDs having other PAL grants including a PAL grant of the lessor and from being interfered with by CBSDs having general authorized access (GAA) grants.

Here, a maximum allowed transmission power of a CBSD, that is, in particular, a maximum allowed transmission power for a PAL grant issued by an SAS to the CBSD of the lessor may be considerably reduced depending on the magnitude of interference power of interference with a PPA of the lessee from the CBSD having the PAL grant of the lessor. Such a reduction in a maximum allowed transmission power for the PAL grant of the lessor due to the PPA for the CBSD of the lessee is not essentially desirable to the lessor, the PPA being based on the PAL grant of the lessee.

However, a system used to avoid such a phenomenon is not provided currently by the CBRS. Such a phenomenon can be avoided by limiting an area leasable to a lessee to a range in which interference is sufficiently reduced. However, a leasable range may be considerably reduced in this case.

What has been pointed out above is an issue from the viewpoint of lessors, although there may also occur a similar issue from the viewpoint of lessees. In other words, a maximum allowed transmission power for a CBSD, that is, in particular, a maximum allowed transmission power for a PAL grant issued by an SAS to the CBSD of the lessee may be considerably reduced depending on the magnitude of interference power of interference with a PPA of the lessor from the CBSD with the PAL grant of the lessee. Such a reduction in a maximum allowed transmission power for the PAL grant of a PAL leased from the lessor may be undesirable to the lessee.

Thus, it is desirable that there is a system that makes it possible to prevent a maximum allowed transmission power for a PAL grant of a lessor or a lessee from being considerably reduced, without a leasable range being considerably reduced.

In view of the circumstances described above, it is an object of the present disclosure to introduce a system used to avoid reducing an allowed transmission power of a communication apparatus.

### Solution to Problem

A communication control apparatus according to the present disclosure includes a processor that acquires information indicating a priority relationship in interference protection between a first communication apparatus and a second communication apparatus that each transmit radio waves, that determines an amount of a reduction in a transmission power of the first communication apparatus on the basis of the information indicating the priority relationship and an allowed interference power of the second communication apparatus, and that determines an allowed transmission power of the first communication apparatus on the basis of the reduction amount.

### BRIEF DESCRIPTION OF DRAWINGS

FIG. 1 illustrates a system model according to an embodiment of the present disclosure.

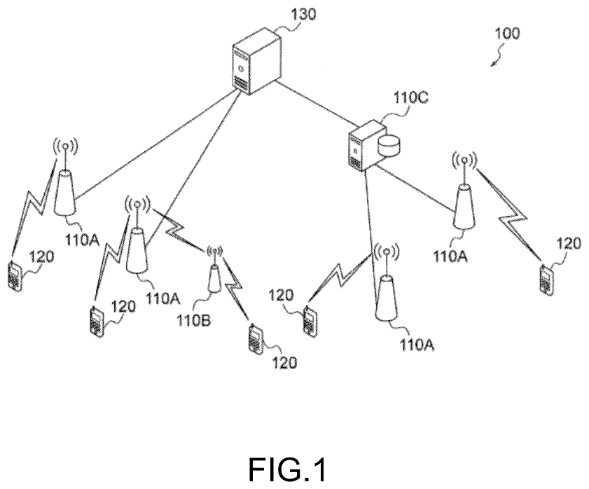

FIG. 2 illustrates a network configuration to which autonomous decision-making may be applied.

FIG. 3 illustrates a network configuration to which centralized decision-making may be applied.

FIG. 4 illustrates a network configuration to which both the centralized decision-making and distributed decision-making are applied.

FIG. 5 is a diagram used to describe a three-tier structure in the CBRS.

FIG. 6 is a diagram used to describe signaling performed between terminals.

FIG. 7 is a block diagram of a communication system according to the present embodiment.

FIG. 8 schematically illustrates interference considered between a CBSD of a lessor and each of CBSDs of lessees.

FIG. 9 is a flowchart of processing performed to calculate, using an IAP, transmission power allowed to a communication apparatus.

FIG. 10 illustrates an example of excluding a grant for a CBSD of the lessor from a target for performing the IAP with respect to each of PPAs of the lessees.

FIG. 11 illustrates an example in which one operator holds PALs for one channel in counties 1 and 2 and leases the PALs in the respective counties.

FIG. 12 illustrates an example in which different operators respectively hold PALs for one channel in the counties 1 and 2 and lease their own PALS.

### MODE(S) FOR CARRYING OUT THE INVENTION

Embodiments of the present disclosure will now be described below with reference to the drawings. Elements included in at least one embodiment according to the present disclosure can be combined, and a result obtained by the combining is also a portion of the at least one embodiment according to the present disclosure.

### 1. Assumed Representative Scenario

### <1.1 System Model>

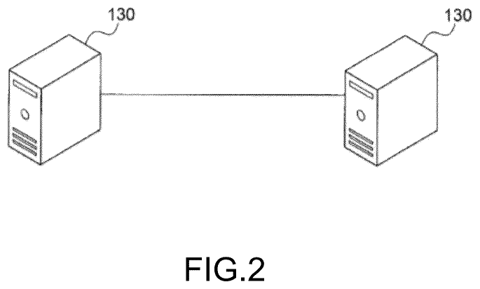

FIG. 2 illustrates a system model according to an embodiment of the present disclosure. As illustrated in FIG. 2, the system model is represented by a communication network 100 including wireless communication, and typically includes the following entities.
communication apparatus 110
terminal 120
communication control apparatus 130

Further, the system model at least includes a primary system and a secondary system that use the communication network 100. Each of the primary system and the secondary system includes the communication apparatus 110, or the communication apparatus 110 and the terminal 120. Each of various communication systems can be used as the primary system or the secondary system. In the present embodiment, the primary system and the secondary system use a portion or all of a frequency band. Note that respective frequency bands assigned to the primary system and the secondary system partially or completely overlap in some cases, or do not overlap at all in other cases. In other words, the system model is described as a model of a wireless communication system related to dynamic spectrum access (DSA). Note that the system model is not limited to systems related to the dynamic spectrum access.

Typically, the communication apparatus 110 is a wireless apparatus, such as a wireless base station (including a base station, Node B, eNB, and gNB) or a wireless access point (an access point), that provides wireless communication services to the terminal 120. In other words, the communication apparatus 110 provides wireless communication services to enable the terminal 120 to perform wireless communication. Further, the communication apparatus 1 may be a wireless relay apparatus or an optical extension apparatus called a remote radio head (RRH). In the following description, the communication apparatus 110 is assumed to be an entity that is included in the secondary system, unless otherwise specified.

The coverage (a communication region) provided by the communication apparatus 110 can be sized variously from a large size such as a macrocell to a small size such as a picocell. A plurality of communication apparatuses 110 may form a single cell, as in the case of a distributed antenna system (DAS). Further, a cell or a service area may be formed for each beam when the communication apparatus 110 is capable of beamforming.

In the present disclosure, it is assumed that there are two different types of communication apparatuses 110.

In the present disclosure, the communication apparatus 110 being capable of accessing the communication control apparatus 130 without using a wireless path that requires permission of the communication control apparatus 130 is referred to as a “communication apparatus 110A”. Specifically, for example, the communication apparatus 110 being capable of establishing an Internet connection by wire can be considered the “communication apparatus 110A”. Further, for example, a wireless relay apparatus that does not include a function of establishing an Internet connection by wire can also be considered the “communication apparatus 110A” if a wireless backhaul link that uses a spectrum that requires no permission of the communication control apparatus 130 has been established between the wireless relay apparatus and another communication apparatus 110A.

In the present disclosure, the communication apparatus 110 not being allowed to access the communication control apparatus 130 without a wireless path that requires permission of the communication control apparatus 130 is referred to as a “communication apparatus 110B”. For example, a wireless relay apparatus for which it is necessary to establish a backhaul link using a spectrum that requires permission of the communication control apparatus 130 can be considered the “communication apparatus 110B”. Further, for example, an apparatus such as a smartphone that includes a wireless network providing function as represented by tethering and that uses a spectrum that requires permission of the communication control apparatus 130 for both a backhaul link and an access link can be used as the “communication apparatus 110B”.

The communication apparatus 110 does not necessarily have to be installed in a fixed manner. For example, the communication apparatus 110 may be installed in a mobile object such as an automobile. Further, the communication apparatus 110 does not necessarily have to be on the ground. For example, an object, such as an aircraft, a drone, a helicopter, a high-altitude platform station (HAPS), a balloon, or a satellite, that is in the air or in space may include the communication apparatus 110. Further, for example, an object, such as a ship or a submarine, that is on or in the sea may include the communication apparatus 110. Typically, such a mobile communication apparatus 110 corresponds to the communication apparatus 110B, and communicates with the communication apparatus 110A wirelessly to secure an access path to the communication control apparatus 130. Of course, even the mobile communication apparatus 110 can be used as the communication apparatus 110A if a spectrum used to communicate with the communication apparatus 110A wirelessly is unmanaged by the communication control apparatus 130.

In the present disclosure, the term “communication apparatus 110” means both the communication apparatus 110A and the communication apparatus 110B, and may be replaced with either one of them, unless otherwise specified.

The communication apparatus 110 may be used, operated, or managed by various operators. For example, mobile network operators (MNOs), mobile virtual network operators (MVNOs), mobile network enablers (MNEs), mobile virtual network enablers (MVNEs), shared facilities operators, neutral host network (NHN) operators, broadcasters, enterprises, educational institutions (such as educational foundations, and boards of education of respective local governments), real estate (such as buildings and condominiums) managers, and individuals may be assumed to be operators related to the communication apparatus 110. Note that the operator related to the communication apparatus 110 is not particularly limited. Further, the communication apparatus 110A may be shared facilities used by a plurality of operators. Furthermore, the facilities may be installed, used, operated, and managed by different operators.

Typically, the communication apparatus 110 operated by the operator is connected to the Internet through a core network. Further, the operation, management, and maintenance are performed using a function called Operation, Administration, and Maintenance (OA&M). Furthermore, there may exist, for example, an intermediate apparatus (a network manager) 110C that performs integrated control on the communication apparatuses 110 in a network, as illustrated in FIG. 2. Note that the intermediate apparatus may be the communication apparatus 110 or the communication control apparatus 130.

The terminal 120 (such as user equipment, a user terminal, a user station, a mobile terminal, and a mobile station) is an apparatus that performs wireless communication using wireless communication services provided by the communication apparatus 110. Typically, a communication apparatus such as a smartphone corresponds to the terminal 120. Note that any apparatus including a function of wireless communication can correspond to the terminal 120. For example, an apparatus such as a camera for business use that includes a function of wireless communication but is not principally used for wireless communication can also correspond to the terminal 120. Further, a communication apparatus that transmits data to the terminal 120 also corresponds to the terminal 120, where examples of the communication apparatus include a broadcasting wireless station (a field pickup unit (FPU)) that transmits, for example, images used for television broadcasts from a place outside of a broadcasting station (the spot) to the broadcasting station in order to broadcast, for example, sports events. Furthermore, the terminal 120 does not necessarily have to be used by humans. For example, an apparatus such as a machine in a factory or a sensor installed in a building may be connected to a network to operate as the terminal 120, which is what is called machine type communication (MTC). Moreover, an apparatus called customer premises equipment (CPE) provided in order to secure Internet connection may operate as the terminal 120.

Further, the terminal 120 may include a relay communication function as represented by device-to-device (D2D) or vehicle-to-everything (V2X).

Furthermore, the terminal 120 does not necessarily have to be installed in a fixed manner or to be on the ground, as in the case of the communication apparatus 110. For example, an object, such as an aircraft, a drone, a helicopter, or a satellite, that is in the air or in space may operate as the terminal 120. Further, for example, an object, such as a ship or a submarine, that is on or in the sea may operate as the terminal 120.

In the present disclosure, unless otherwise specified, the terminal 120 corresponds to an entity at which a radio link that uses a spectrum that requires permission of the communication control apparatus 130 is terminated. Note that, depending on a function included in the terminal 120 or an applied network topology, the terminal 120 may perform operation equivalent to the operation performed by the communication apparatus 110. In other words, depending on the network topology, an apparatus that can correspond to the communication apparatus 110 such as a wireless access point may correspond to the terminal 120, or an apparatus that can correspond to the terminal 120 such as a smartphone may correspond to the communication apparatus 110.

Typically, the communication control apparatus 130 is an apparatus that determines a communication parameter for the communication apparatus 110, permits the use of the communication parameter, gives an instruction regarding the communication parameter, and/or manages the communication parameter. For example, a database server called a TV white space database (TVWSDB), a geolocation database (GLDB), a Spectrum Access System (SAS), or Automated Frequency Coordination (AFC) corresponds to the communication control apparatus 130. In other words, a database server that is authorized to, or serves a function to perform certification for or surveillance on radio waves with respect to spectrum secondary use can be considered the communication control apparatus 130.

A database server that serves a function that is different from the function described above also corresponds to the communication control apparatus 130. For example, a control apparatus that performs control on radio-wave interference between communication apparatuses also corresponds to the communication control apparatus 130, where a Spectrum Manager (SM) in EN 303 387 of the European Telecommunications Standards Institute (ETSI), a Coexistence Manager (CM) in the Institute of Electrical and Electronics Engineers (IEEE) 802.19.1-2018, and a Coexistence Manager (CxM) in CBRSA-TS-2001 are representative of the control apparatus. Further, for example, a Registered Location Secure Server (RLSS) defined in IEEE 802.11-2016 also corresponds to the communication control apparatus 130. In other words, without being limited to these examples, any entity that plays a role in, for example, determining a communication parameter for the communication apparatus 110, permitting the use of the communication parameter, giving an instruction regarding the communication parameter, and managing the communication parameter may be called the communication control apparatus 130. In principle, the control target for the communication control apparatus 130 is the communication apparatus 110. However, the communication control apparatus 130 may control the terminal 120 subordinate to the communication apparatus 110.

A combination of a plurality of database servers respectively serving different functions also corresponds to the communication control apparatus 130. For example, CBRS Alliance SAS (CSAS) corresponding to a combination of SAS and CxM that is described in CBRSA-TS-2001 can also be considered the communication control apparatus 130.

The communication control apparatus 130 can also be implemented by providing a database server with software including a function equivalent to the function included in the database server. For example, an SAS provided with a function or software that is equivalent to CxM can also be considered the communication control apparatus 130.

There may be a plurality of the communication control apparatuses 130 serving similar functions. When there is the plurality of communication control apparatuses 130 serving similar functions, at least one of three types of decision-making topologies indicated below can be applied to the communication control apparatus 130.
autonomous decision-making
centralized decision-making
distributed decision-making

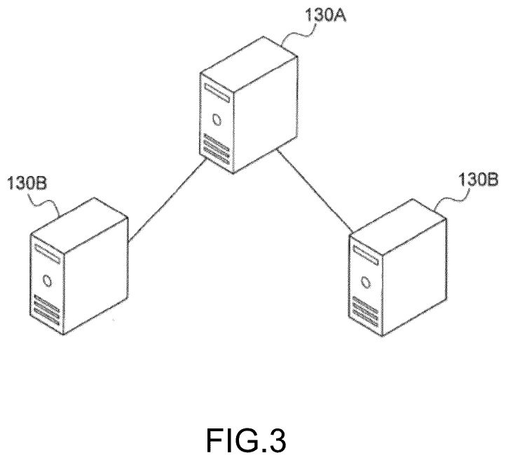

The autonomous decision-making is a decision-making topology in which a decision-making entity (a decision-making entity, that is, the communication control apparatus 130 here) makes a decision independently of another decision-making entity. The communication control apparatus 130 independently calculates necessary spectrum assignment and interference control. For example, the autonomous decision-making can be applied when a plurality of communication control apparatuses 130 is arranged in a distributed manner, as illustrated in FIG. 3.

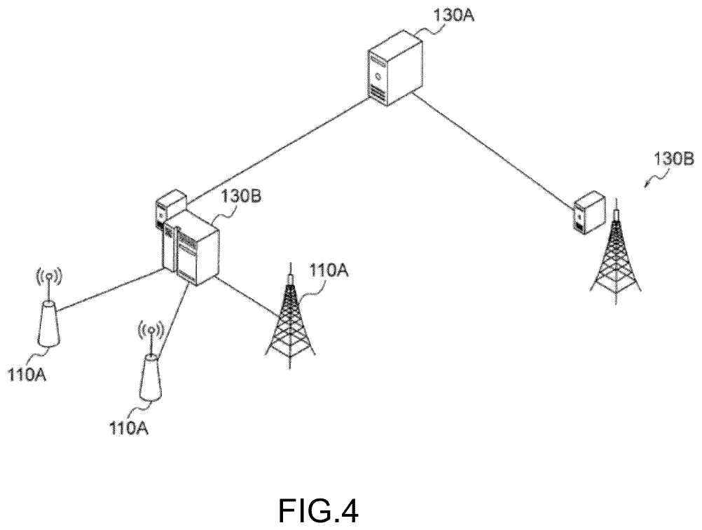

The centralized decision-making is a decision-making topology in which a decision-making entity delegates decision making to another decision-making entity. For example, a model as illustrated in FIG. 4 can be assumed when the centralized decision-making is performed. FIG. 4 illustrates a model (what is called a master-slave model) in which a single communication control apparatus 130 performs centralized control on a plurality of communication control apparatuses 130. In the model illustrated in FIG. 4, a communication control apparatus 130A that corresponds to a master can control communication control apparatuses 130B that correspond to a plurality of slaves to make a decision in a centralized manner.

The distributed decision-making is a decision-making topology in which a decision-making entity makes a decision in cooperation with another decision-making entity. For example, communication control apparatuses 130 of a plurality of communication control apparatuses 130 make decisions independently of each other, as in the case of the autonomous decision-making in FIG. 3, and, after making the decisions, the communication control apparatuses 130 of the plurality of communication control apparatuses 130 mutually perform, for example, adjustment of their decision-making results and negotiations on the decision-making results. This may correspond to the “distributed decision-making”. Further, for example, the communication control apparatus 130A corresponding to a master dynamically performs, for example, transfer of authority over decision making to each of the communication control apparatuses 130B corresponding to slaves, or revoking of the authority of the communication control apparatus 130B in the centralized decision-making in FIG. 4, for the purpose of, for example, load balancing. This can also be considered the “distributed decision-making”.

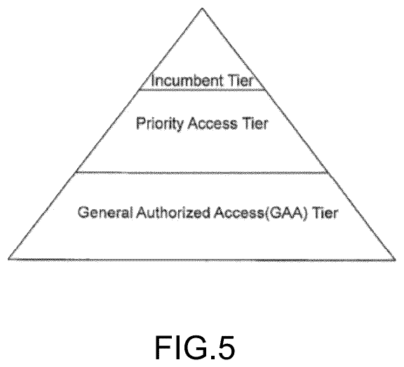

Both the centralized decision-making and the distributed decision-making may be applied. In FIG. 5, the communication control apparatus 130B corresponding to a slave operates as an intermediate apparatus that manages a plurality of communication apparatuses 110 collectively. The communication control apparatus 130A does not have to control the communication apparatuses 110 collectively managed by the communication control apparatus 130B corresponding to a slave, that is, the communication control apparatus 130A does not have to control the secondary system including the communication control apparatus 130B corresponding to a slave. As described above, the implementation as illustrated in FIG. 5 can also be adopted as a modification.

The communication control apparatus 130 may also acquire, for its functions, necessary information from an entity other than the communication apparatus 110 and terminal 120 included in the communication network 100. Specifically, for example, the communication control apparatus 130 may acquire information necessary to protect the primary system from a database (a regulatory database) managed or operated by a national or regional radio administrative agency (a National Regulatory Authority (NRA)). Examples of the regulatory database include the Universal Licensing System (ULS) operated by the Federal Communications Commissions (FCC). Examples of the information necessary to protect the primary system include position information regarding a position of the primary system, a communication parameter for the primary system, an out-of-band emission (OOBE) limit, an adjacent channel leakage ratio (ACLR), adjacent channel selectivity, a fading margin, and a protection ratio (PR). It is desirable that, in a region in which, for example, a fixed numerical value, an acquisition method, and a derivation method are demanded by, for example, a law in order to protect the primary system, information demanded by the law be used as the information necessary to protect the primary system.

Further, a database that records therein information regarding the communication apparatus 110 and terminal 120 certified for conformity by, for example, the Equipment Authorization System (EAS) managed by the Office of Engineering and Technology (OET) of the FCC, also corresponds to the regulatory database. For example, information regarding a spectrum at which the communication apparatus 110 or the terminal 120 is operable, and information regarding the maximum equivalent isotropic radiated power (EIRP) can be acquired from such a regulatory database. Of course, the communication control apparatus 130 may use these pieces of information to protect the primary system.

Further, it can also be assumed that the communication control apparatus 130 acquires radio wave sensing information from a radio wave sensing system that is installed and operated for the purpose of detecting radio waves in the primary system. In the Citizens Broadband Radio Service (CBRS) in the United States, the communication control apparatus 130 acquires, from a radio wave sensing system called an Environmental Sensing Capability (ESC), radio wave detection information regarding radio waves of a radar on ship that corresponds to the primary system. This is a specific example of the acquisition of the radio wave sensing information. Further, the communication control apparatus 130 may acquire radio wave detection information regarding radio waves in the primary system from the communication apparatus 110 or the terminal 120 when the communication apparatus 110 and the terminal 120 each include a sensing function.

Further, it can also be assumed that the communication control apparatus 130 acquires activity information regarding an activity of the primary system from a portal system that manages the activity information regarding an activity of the primary system. In the Citizens Broadband Radio Service (CBRS) in the United States, the communication control apparatus 130 acquires the activity information regarding an activity of the primary system from a calendar-type system called Informing Incumbent Portal. This is a specific example of the acquisition of the activity information. The primary system is protected by enabling a protection area called a dynamic protection area (DPA), on the basis of the acquired activity information. The primary system is also protected by an equivalent system called Informing Incumbent Capability (IIC) using a similar approach.

An interface between entities included in the system model may be wired or wireless. For example, not only a wired link but also a wireless interface that is not dependent on spectrum sharing may be used as an interface between the communication control apparatus 130 and the communication apparatus 110. Examples of the wireless interface not being dependent on spectrum sharing include a wireless communication link that is provided by a mobile network operator via a licensed band, and Wi-Fi communication performed using an existing license-exempt band.

### <1.2 Regarding Terms Related to Spectrum and Sharing>

As described above, the present embodiment will be described on the assumption of a dynamic spectrum access environment. A system defined by the CBRS in the United States (that is, a system defined in Part 96 Citizens Broadband Radio Service of the FCC Rules in the United States) is described as a representative example of the dynamic spectrum access.

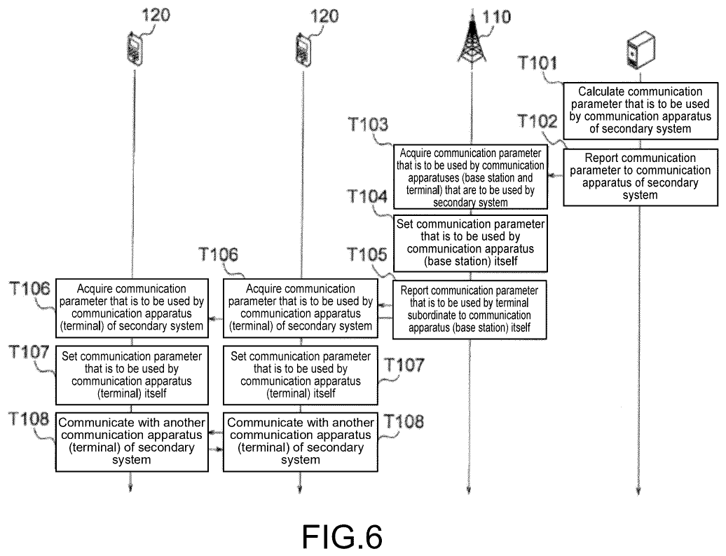

In the CBRS, users in a frequency band are classified into three groups, as illustrated in FIG. 6. The group is referred to as a tier. The three groups are respectively referred to as an incumbent tier, a priority access tier, and a general authorized access (GAA) tier.

The incumbent tier is a group that includes an existing user who conventionally uses the frequency band. Typically, the existing user is also referred to as a primary user. In the CBRS, the Department of Defense (DOD) in the United States, a fixed satellite operator, and a wireless broadband licensee exempted from a new rule (grandfathered wireless broadband licensees (GWBLs)) are defined as the existing users. It is not necessary that the incumbent tier avoid interfering with the priority access tier and GAA tier each having a lower priority or reduce use of the frequency band. Further, the incumbent tier is protected from being interfered with by the priority access tier and the GAA tier. In other words, the user included in the incumbent tier can use the frequency band without taking into consideration the presence of other groups.

The priority access tier is a group that includes a user who uses the frequency band on the basis of the priority access license (PAL) described above. Typically, the user included in the priority access tier is also referred to as a secondary user. It is necessary that, upon using the frequency band, the priority access tier avoid interfering with the incumbent tier having a higher priority than the priority access tier and reduce use of the frequency band relative to the incumbent tier. On the other hand, it is not necessary that the priority access tier avoid interfering with the GAA tier having a lower priority than the priority access tier or reduce use of the frequency band relative to the GAA tier. Further, the priority access tier is not protected from being interfered with by the incumbent tier having a higher priority, whereas the priority access tier is protected from being interfered with by the GAA tier having a lower priority.

The GAA tier is a group that includes a user, in the frequency band, who does not belong to the incumbent tier or the priority access tier. Typically, the user included in the GAA tier is also referred to as a secondary user, as in the case of the priority access tier. However, the GAA tier has a lower priority in shared use than the priority access tier. Thus, the GAA tier is also referred to as a low-priority secondary user. It is necessary that, upon using the frequency band, the GAA tier avoid interfering with the incumbent tier and priority access tier each having a higher priority, or reduce use of the frequency band relative to the incumbent tier and priority access tier each having a higher priority. Further, the GAA tier is not protected from being interfered with by the incumbent tier or priority access tier each having a higher priority.

The CBRS system has been described above as a representative example of the dynamic spectrum access. However, the present embodiment is not limited to the definition of the CBRS. For example, a three-tier structure is typically adopted in the CBRS, as illustrated in FIG. 6. However, a two-tier structure may be adopted in the present embodiment. Representative examples of the two-tier structure include structures in authorized shared access (ASA), licensed shared access (LSA), evolved LSA (eLSA), a TV band white space (TVWS), and sharing use of the 6 GHZ band in the United States. In the ASA, the LSA, and the eLSA, there is no GAA tier, and a structure equivalent to a combination of the incumbent tier and the priority access tier is adopted. Further, in the TVWS and the sharing use of the 6 GHz band in the United States, there is no priority access tier, and a structure equivalent to a combination of the incumbent tier and the GAA tier is adopted. Furthermore, there may be four or more tiers. Specifically, for example, a plurality of intermediate layers corresponding to the priority access tiers may be provided, and different priorities may be given to the respective intermediate layers to generate four or more tiers. Moreover, for example, the GAA tier may be divided similarly, and priorities may be given to tiers obtained by the division to increase the number of tiers. In other words, each group may be divided.

Further, the primary system of the present embodiment is also not limited to the definition of the CBRS. For example, wireless systems such as TV broadcasting, a fixed microwave link (a fixed system (FS)), a meteorological radar, a radio altimeter, Communications-based Train Control, and a radio astronomy are assumed as examples of the primary system. Furthermore, the present embodiment is not limited thereto, and any wireless systems can be the primary system of the present embodiment.

Further, the present embodiment is not limited to the spectrum sharing environment, as described above. Typically, an existing system that uses a target frequency band is referred to as the primary system, and a secondary user is referred to as the secondary system in spectrum sharing or spectrum secondary use. However, these terms should be read by being replaced with other terms when the present embodiment is applied to an environment other than the spectrum sharing environment. For example, a macrocell base station in a heterogeneous network (HetNet) may be referred to as the primary system, and a small-cell base station and a relay station may be referred to as the secondary system. Furthermore, a base station may be referred to as the primary system, and relay user equipment (UE) or vehicle UE that exists inside of the coverage of the base station and that provides D2D or V2X may be referred to as the secondary system. The base station is not limited to being fixed, and may be a portable or mobile base station. In such a case, for example, the communication control apparatus 130 of the present embodiment may be included in, for example, a core network, a base station, a relay station, or relay UE.

Further, when the present embodiment is applied to an environment other than the spectrum sharing environment, the term “frequency/spectrum” in the present disclosure is replaced with another term shared in the other environment. For example, the term “frequency/spectrum” is assumed to be replaced with a term such as “resource”, “resource block”, “resource element”, “resource pool”, “channel”, “component carrier”, “carrier”, “subcarrier”, or “bandwidth part (BWP)”, or another term having a meaning equivalent or similar thereto.

### 2. Description of Various Procedures Assumed in Present Embodiment

Here, a basic procedure that can be used upon practicing the present embodiment is described. Note that, in the description of the sections up to <2.5> described later, the procedures are assumed to be primarily performed in the communication apparatus 110A.

### <2.1 Registration Procedure>

A registration procedure is a procedure performed to register information regarding a wireless system that intends to use a frequency band. More specifically, the registration procedure is a procedure performed to register, with the communication control apparatus 130, a device parameter related to the communication apparatus 110 of the wireless system. Typically, the communication apparatus 110 representative of a wireless system that intends to use a frequency band reports a registration request including the device parameter to the communication control apparatus 130, and this results in starting the registration procedure. Note that, when a plurality of communication apparatuses 110 belongs to a wireless system that intends to use a frequency band, the registration request includes the device parameter for each of the plurality of communication apparatuses. Further, an apparatus that transmits the registration request as a representative of the wireless system may be determined as appropriate.

### <2.1.1 Details of Necessary Parameter>

For example, the device parameter refers to information indicated below.
Information regarding a user of the communication apparatus 110 (hereinafter referred to as user information)
Information unique to the communication apparatus 110 (hereinafter referred to as unique information)
Information regarding a position of the communication apparatus 110 (hereinafter referred to as position information)
Information regarding an antenna included in the communication apparatus 110 (hereinafter referred to as antenna information)
Information regarding a wireless interface included in the communication apparatus 110 (hereinafter referred to as wireless interface information)
Legal information regarding the communication apparatus 110 (hereinafter referred to as legal information)
Information regarding an installer of the communication apparatus 110 (hereinafter referred to as installer information)
Information regarding a group to which the communication apparatus 110 belongs (hereinafter referred to as group information)

The device parameter is not limited to the pieces of information describe above. Information other than the pieces of information describe above may be used as the device parameter. Note that the device parameters do not have to be transmitted at a time, and may be transmitted at multiple times in a divided manner. In other words, a plurality of registration requests may be transmitted for a single registration procedure. As described above, a procedure or a process in the procedure may be performed at multiple times in a divided manner. The same applies to procedures described below.

The user information is information related to a user of the communication apparatus 110. For example, a user ID, an account name, a user name, user's contact information, and a call sign can be assumed as the user information. The user ID and the account name may be independently generated by the user of the communication apparatus 110, or may be issued by the communication control apparatus 130 in advance. Regarding the call sign, it is desirable to use a call sign issued by an NRA.

For example, the user information can be used for the purpose of interference resolution. The following is a specific example. In a spectrum-use-report procedure described in <2.5> described later, the communication control apparatus 130 performs use stop determination on a spectrum that is being used by the communication apparatus 110 and gives an instruction based on the use stop determination, but a spectrum-use-report request regarding the spectrum may be reported continuously. In this case, suspecting a failure in the communication apparatus 110, the communication control apparatus 130 can make contact with the user using the user's contact information included in the user information to make a behavior check request for checking of the behavior of the communication apparatus 110. Without being limited to this example, the communication control apparatus 130 can make contact using the user information when it is determined that the communication apparatus 110 is performing an operation counter to communication control performed by the communication control apparatus 130.

Examples of the unique information include information with which the communication apparatus 110 can be specified, product information regarding the communication apparatus 110, and information regarding hardware or software of the communication apparatus 110.

Example of the information with which the communication apparatus 110 can be specified can include a serial number of the communication apparatus 110, and an ID of the communication apparatus 110. For example, the ID of the communication apparatus 110 may be independently provided by the user of the communication apparatus 110.

Examples of the product information regarding the communication apparatus 110 may include an authentication ID, a product model number, and information regarding a manufacturer. For example, the authentication ID is an ID provided by a certification authority in each country or region, such as an FCC ID in the United States, a CE number in Europe, and a technical standards conformity certification (a technical standards conformity) in Japan. An ID issued by, for example, an industrial association on the basis of a unique authentication program may also be considered the authentication ID.

The unique information as represented by the pieces of information described above may be used for, for example, a permission list (allowlist) or a refusal list (denylist). When, for example, any information regarding the communication apparatus 110 in operation is included in the refusal list, the communication control apparatus 130 can instruct the communication apparatus 110 to stop using a spectrum in the spectrum-use-report procedure described in <2.5> described later. Further, the communication control apparatus 130 can perform a behavior of not canceling a use stop measure until the communication apparatus 110 is released from the refusal list. Furthermore, for example, the communication control apparatus 130 can refuse registration of the communication apparatus 110 included in the refusal list. Further, for example, the communication control apparatus 130 can also perform an operation of not considering, upon interference calculation in the present disclosure, the communication apparatus 110 corresponding to the information included in the refusal list, or an operation of only considering, upon the interference calculation, the communication apparatus 110 corresponding to the information included in the permission list.

Note that, in the present disclosure, the FCC ID may be used as information regarding transmission power. For example, in the Equipment Authorization System (EAS) database, which is a type of regulatory database, information regarding an apparatus for which certification has been acquired can be acquired, and an application programming interface (API) thereof is also disclosed. For example, the information can include, together with the FCC ID, maximum EIRP information (certified maximum EIRP) for which certification has been acquired. Since such power information is associated with the FCC ID, the FCC ID can be used as the transmission power information. Likewise, the FCC ID may be used as what is equivalent to other information included in the EAS. Further, when not only the FCC ID but also information associated with an authentication ID is present, the authentication ID may also be used as what is equivalent to the information.

The information regarding hardware of the communication apparatus 110 can include, for example, transmission-power-class information. For example, two types of classes Category A and Category B are defined for the transmission-power-class information in Title 47 Code of Federal Regulations (C.F.R) Part 96 in the United States, and information regarding hardware of the communication apparatus 110 compliant with the definitions can include information regarding which of the two types of classes it belongs to. Further, some classes for eNodeB and gNodeB are defined in TS36.104 and TS38.104 of 3rd Generation Partnership Project (3GPP), and the definitions can also be used.

For example, the transmission-power-class information can be used for the purpose of interference calculation. The interference calculation can be performed using, as transmission power of the communication apparatus 110, maximum transmission power defined for each class.

The information regarding software of the communication apparatus 110 can include, for example, version information and a build number regarding an execution program into which processing necessary for interaction with the communication control apparatus 130 has been written. Further, the information regarding software of the communication apparatus 110 may also include, for example, version information regarding software used for operating as the communication apparatus 110 and a build number of the software.

Typically, the position information is information with which a position of the communication apparatus 110 can be specified. For example, the position information is coordinate information acquired using a positioning function as represented by the Global Positioning System (GPS), Beidou, the Quasi-Zenith Satellite System (QZSS), Galileo, or the Assisted Global Positioning System (A-GPS). Typically, the position information can include information related to latitude, longitude, height above ground/height above sea level, altitude, and positioning error. Alternatively, for example, the position information may be position information registered with an information management apparatus managed by a National Regulatory Authority (NRA) or an organization entrusted by the NRA. Alternatively, the position information may be, for example, coordinates of an X axis, a Y axis, and a Z axis, with a specific geographical position being an origin. Furthermore, an identifier that indicates whether the communication apparatus 110 is situated outdoors or indoors can be provided together with such coordinate information.

Further, the position information may include positioning accuracy information (location uncertainty). For example, both of or one of a horizontal plane and a vertical plane can be provided as the positioning accuracy information. For example, the positioning accuracy information (location uncertainty) can be used as a correction value when a distance to any point is calculated. Furthermore, for example, the positioning accuracy information can also be used as region information regarding a region in which the communication apparatus 110 is likely to be situated. In this case, the positioning accuracy information is used to perform processing of specifying spectrum information that can be used in a region indicated by the positioning accuracy information.

Furthermore, the position information may be information indicating a region in which the communication apparatus 110 is situated. For example, information, such as a postal code or an address, that indicates a region determined by a government, may be used. Further, for example, the region may be represented by at least three sets of geographical coordinates. These pieces of information indicating a region may be provided together with coordinate information.

Further, when the communication apparatus 110 is situated indoors, the position information can also include information indicating a floor of a building in which the communication apparatus 110 is situated. For example, the position information can include identifiers that indicates, for example, the number of floors, the ground, and the underground. Furthermore, for example, the position information can include information, such as a room number and a room name in a building, that indicates a further closed space inside of the building.

Typically, the positioning function is desirably included in the communication apparatus 110. However, there is a possibility that a performance of the positioning function will not satisfy a desired accuracy. Further, there is a possibility that, even if the performance of the positioning function satisfies the desired accuracy, the position information satisfying the desired accuracy will not be acquired at all times depending on where the communication apparatus 110 is installed. Thus, an apparatus that is different from the communication apparatus 110 may include the positioning function, and the communication apparatus 110 may acquire information related to a position from the different apparatus. The apparatus including the positioning function may be a usable existing apparatus, or may be provided by an installer of the communication apparatus 110. In such a case, the position information measured by the installer of the communication apparatus 110 is desirably written into the communication apparatus 110.

Typically, the antenna information is information that indicates, for example, a performance and a configuration of an antenna included in the communication apparatus 110. Typically, the antenna information can include information such as an antenna installation height, a tilt angle (downtilt), a horizontal orientation (azimuth), a boresight, an antenna peak gain, and an antenna model.

Further, the antenna information can also include information regarding a formable beam. For example, the antenna information can include information such as a beam width, a beam pattern, and an analog or digital beamforming capability.

Furthermore, the antenna information can also include information regarding a performance and a configuration of multiple input multiple output (MIMO) communication. For example, the antenna information can include information such as the number of antenna elements and a maximum number of spatial streams (or the number of MIMO layers). Further, the antenna information can also include, for example, codebook information to be used, and weight matrix information. The weight matrix information includes a unitary matrix, a zero-forcing (ZF) matrix, and a minimum mean square error (MMSE) matrix that are each obtained by singular value decomposition (SVD), eigen value decomposition (EVD), or block diagonalization (BD). Furthermore, when the communication apparatus 110 includes a function such as maximum likelihood detection (MLD) for which non-linear calculation is necessary, the antenna information may include information indicating an included function.

Further, the antenna information may include a zenith of direction, departure (ZOD). The ZoD is a type of radio wave arrival angle. Note that, instead of being reported by the communication apparatus 110, the ZoD may be estimated by another communication apparatus 110 from radio waves emitted from an antenna of the communication apparatus 110, and may be reported by the other communication apparatus 110. In this case, the communication apparatus 110 may be, for example, an apparatus that operates as a base station or an access point, an apparatus that performs D2D communication, or a moving relay base station. The ZoD can be estimated using a technology, such as Multiple Signal Classification (MUSIC) or Estimation of Signal Propagation via Rotation Invariance Techniques (ESPRIT), that is used to estimate an arrival direction of radio waves. Furthermore, the ZoD can be used by the communication control apparatus 130 as measurement information.

Typically, the wireless interface information is information indicating a wireless interface technology that is included in the communication apparatus 110. For example, identifier information indicating a technology used in GSM, CDMA2000, UMTS, E-UTRA, E-UTRA NB-IoT, 5G NR, 5G NR NB-IoT, or a further next-generation cellular system can be included as the wireless interface information. Further, identifier information indicating a derivative technology compliant with Long Term Evolution (LTE)/5G such as MulteFire, Long Term Evolution-unlicensed (LTE-U), or NR-unlicensed (NR-U) can also be included. Furthermore, identifier information indicating standard technologies such as a metropolitan area network (MAN) including WiMAX and WiMAX2+, and a wireless LAN of the IEEE 802.11 series can also be included. Furthermore, identifier information indicating an extended global platform (XGP) or a shared XGP (SXGP) may be adopted. Identifier information regarding a communication technology for local power, wide area (LPWA) may be adopted. Further, identifier information indicating a proprietary wireless technology can also be included. Furthermore, a version number or a release number of technical specifications that define these technologies can also be included as the wireless interface information.

Further, the wireless interface information can also include frequency band information regarding a frequency band that is supported by the communication apparatus 110. For example, the frequency band information can be represented by an upper frequency, a lower frequency, a center frequency, a bandwidth, a 3GPP operating band number, or a combination of at least two of them. Furthermore, the wireless interface information can include at least one piece of frequency band information.

Information indicating a capability of a band extension technology such as carrier aggregation (CA) or channel bonding can be further included as the frequency band information regarding a frequency band supported by the communication apparatus 110. For example, combinable pieces of band information can be included. Further, the carrier aggregation can also include information regarding a band desired to be used as a primary component carrier (PCC) or a secondary component carrier (SCC). Furthermore, the number of component carriers (the number of CCs) that can be aggregated at a time can also be included.

Information indicating a combination of frequency bands supported by dual connectivity or multi-connectivity may be further included as the frequency band information regarding a frequency band supported by the communication apparatus 110. In addition, information regarding another communication apparatus 110 that provides the dual connectivity or the multi-connectivity in cooperation may also be provided. The communication control apparatus 130 may determine communication control disclosed in the present embodiment in consideration of another communication apparatus 110 having a cooperative relationship or the like in subsequent procedures.

Information indicating radio-wave-use priority such as PAL and GAA may also be included as the frequency band information regarding a frequency band supported by the communication apparatus 110.

Further, the wireless interface information can also include modulation scheme information regarding a modulation scheme that is supported by the communication apparatus 110. For example, information indicating a primary modulation scheme such as frequency shift keying (FSK), n-value phase shift keying (PSK, where n is a power of two, such as two, four, and eight), and n-value quadrature amplitude modulation (QAM, where n is a power of four, such as 4, 16, 64, 256, and 1024) can be included as representative examples. Furthermore, information indicating a secondary modulation scheme such as orthogonal frequency division multiplexing (OFDM), scalable OFDM, DFT spread OFDM (DFT-S-OFDM), generalized frequency division multiplexing (GFDM), and filter bank multi-carrier (FBMC) can be included.

Further, the wireless interface information can also include information regarding an error correcting code. For example, the wireless interface information can include capabilities of, for example, a turbo code, a low density parity check (LDPC) code, a polar code, and an erasure correcting code; and code rate information regarding a code rate to be applied.

As another aspect, the modulation scheme information and the information regarding an error correcting code can also be represented using a modulation and coding scheme (MCS) index.

Further, the wireless interface information can also include information indicating a function specific to each wireless technical specifications supported by the communication apparatus 110. For example, transmission mode (TM) information defined in LTE is a representative example thereof. Moreover, a specific function that has two or more modes can be included in the wireless interface information, as in the case of the TM information. Further, when there is a function that does not have two or more modes in the technical specifications and when the communication apparatus 110 supports the function not being indispensable in the specifications, information indicating the supported function can also be included.

Furthermore, the wireless interface information can also include radio access technology (RAT) information regarding a radio access technology that is supported by the communication apparatus 110. For example, the wireless interface information can include information indicating, for example, time division multiple access (TDMA), frequency division multiple access (FDMA), orthogonal frequency division multiple access (OFDMA), power division multiple access (PDMA), code division multiple access (CDMA), sparse code multiple access (SCMA), interleave division multiple access (IDMA), spatial division multiple access (SDMA), carrier sense multiple access/collision avoidance (CSMA/CA), and carrier sense multiple access/collision detection (CSMA/CD). Note that TDMA, FDMA, and OFDMA are classified into orthogonal multiple access (OMA). PDMA, CDMA, SCMA, IDMA, and SDMA are classified into non-orthogonal multiple access (NOMA). A representative example of PDMA is an approach performed by a combination of superposition coding (SPC) and successive interference canceller (SIC). CSMA/CA and CSMA/CD are classified into opportunistic access.

When the wireless interface information includes information indicating opportunistic access, the wireless interface information may further include information indicating details of an access scheme. As a specific example, the wireless interface information may include information indicating which of frame-based equipment (FBE) and load-based equipment (LBE) is defined in EN 301 598 of ETSI.

When the radio interface information indicates the LBE, the wireless interface information may further include LBE-specific information such as a priority class.

Further, the wireless interface information can also include information related to a duplex mode that is supported by the communication apparatus 110. As a representative example, the wireless interface information can include, for example, information regarding a scheme such as frequency division duplex (FDD), time division duplex (TDD), and full duplex (FD).

When TDD is included as the wireless interface information, TDD frame structure information regarding a TDD frame structure that is used or supported by the communication apparatus 110 can be provided. Further, information related to a duplex mode may be included for each frequency band indicated by the frequency band information.

When an FD is included as the wireless interface information, information regarding an interference power detection level may be included.

Further, the wireless interface information can also include information regarding a transmission diversity approach that is supported by the communication apparatus 110. For example, space time coding (STC) may be included.

Furthermore, the wireless interface information can also include guard band information. For example, the wireless interface information can include information regarding a guard band size determined in advance for a wireless interface. Alternatively, the wireless interface information may include, for example, information regarding a guard band size desired by the communication apparatus 110.

Regardless of the aspects described above, the wireless interface information may be provided for each frequency band.

Typically, the legal information is, for example, information regarding regulations that are established by a radio administrative agency or an equivalent agency in each country or region and that the communication apparatus 110 has to comply with; and certification information regarding certification that has been acquired by the communication apparatus 110. Typically, the information regarding regulations can include, for example, upper limit information regarding an upper limit of out-of-band emission, and information regarding blocking characteristics of a receiver. Typically, the certification information can include, for example, type approval information, and law-and-regulation information used as a standard upon acquisition of certification. The type approval information corresponds to, for example, an FCC ID in the United States, and a technical standards conformity certification in Japan. The law-and-regulation information corresponds to, for example, an FCC regulation number in the United States, and an ETSI Harmonized Standard number in Europe.

Numerical values that are defined in a standard specification for a wireless interface technology may be substituted for information related to numerical values from among the legal information. The standard specification for a wireless interface technology corresponds to, for example, 3GPP TS36. 104 or TS38.104. An adjacent channel leakage ratio (ACLR) is defined therein. Instead of the upper limit information regarding an upper limit of out-of-band emission, the upper limit of out-of-band emission may be used by being derived using an ACLR defined in the standard specification. Further, the ACLR itself may be used as necessary. Furthermore, adjacent channel selectivity (ACS) may be used instead of the blocking characteristics. Further, those may be used in combination, or an adjacent channel interference ratio (ACIR) may be used. Note that, typically, the ACIR has the following relationship with the ACLR and the ACS.

$$\begin{matrix}[ Math . 1 ] & \\ ACIR = {( \frac{1}{ACS} + \frac{1}{ACLR} )}^{- 1} & ( 1 )\end{matrix}$$

Note that Formula (1) uses an antilogarithmic expression, but may be expressed logarithmically.

The installer information can include, for example, information with which a person (an installer) who has installed the communication apparatus 110 can be specified, and unique information associated with the installer. Typically, the installer information can include information regarding an individual who is responsible for the position information regarding a position of the communication apparatus 110, that is, information regarding a certified professional installer (CPI) defined in Non-Patent Literature 1. A certified professional installer registration ID (a CPIR-ID) and a CPI name are disclosed for the CPI. Further, for example, an address used for contact (a mailing address or a contact address), an email address, a phone number, and a public key identifier (PKI) are disclosed as unique information associated with the CPI. Without being limited thereto, the installer information may include other information regarding the installer as necessary.

The group information can include information regarding a communication apparatus group to which the communication apparatus 110 belongs. Specifically, group information can include, for example, information related to the same type of group as, or a type of group equivalent to what is disclosed in WINNF-SSC-0010. Further, when, for example, a telecommunications operator manages the communication apparatuses 110 for each group according to its own operation policy, the group information can include information regarding the group.

The information listed so far may be estimated by the communication control apparatus 130 from other information provided by the communication apparatus 110, without being provided by the communication apparatus 110 to the communication control apparatus 130. Specifically, for example, the guard band information can be estimated from the wireless interface information. When a wireless interface used by the communication apparatus 110 is an E-UTRA or 5G-NR wireless interface, estimation can be performed on the basis of the E-UTRA transmission bandwidth specifications described in 3GPP TS36.104, the 5G NR transmission bandwidth specifications described in 3GPP TS38.104, and tables described in TS38.104 and indicated below.

TABLE 5.6-1
Transmission bandwidth configuration NRB in E-UTRA channel
bandwidths (cited from Table 5.6-1 in 3GPP TS36.104)

| Channel bandwidth | | | | | | |
|---|---|---|---|---|---|---|
| BW_{Channel} [MHz] | 1.4 | 3 | 5 | 10 | 15 | 20 |
| Transmission | 6 | 15 | 25 | 50 | 75 | 100 |
| bandwidth | | | | | | |
| configuration N_{RB} | | | | | | |

TABLE 5.3.3-1
Minimum guardband (kHz) (FR1) (cited from Table 5.3.3-1 in 3GPP TS38.104)

| SCS | 5 | 10 | 15 | 20 | 25 | 30 | 40 | 50 | 60 | 70 | 80 | 90 | 100 |
|---|---|---|---|---|---|---|---|---|---|---|---|---|---|
| (kHz) | MHz | MHz | MHz | MHz | MHz | MHz | MHz | MHz | MHz | MHz | MHz | MHz | MHz |
| 15 | 242.5 | 312.5 | 382.5 | 452.5 | 522.5 | 592.5 | 552.5 | 692.5 | N.A | N.A | N.A | N.A | N.A |
| 30 | 505 | 665 | 645 | 805 | 785 | 945 | 905 | 1045 | 825 | 965 | 925 | 885 | 845 |
| 60 | N.A | 1010 | 990 | 1330 | 1310 | 1290 | 1610 | 1570 | 1530 | 1490 | 1450 | 1410 | 1370 |

TABLE 3
Table: 5.3.3-2: Minimum guardband (kHz) (FR2)
(cited from Table: 5.3.3-2 in 3GPP TS38.104)

| SCS | 50 | 100 | 200 | 400 |
|---|---|---|---|---|
| (kHz) | MHz | MHz | MHz | MHz |
| 60 | 1210 | 2450 | 4930 | N.A |
| 120 | 1900 | 2420 | 4900 | 9860 |

TABLE 4
Table: 5.3.3-3: Minimum guardband (kHz) of
SCS 240 kHz SS/PBCH block (FR2)
(cited from Table: 5.3.3-3 in 3GPP TS38.104)

| SCS | 100 | 200 | 400 |
|---|---|---|---|
| (kHz) | MHz | MHz | MHz |
| 240 | 3800 | 7720 | 15560 |

In other words, it is sufficient if the communication control apparatus 130 can acquire the information listed so far, and the communication apparatus 110 does not necessarily have to provide the information to the communication control apparatus 130. Further, the intermediate apparatus 130B (for example, a network manager) managing a plurality of communication apparatuses 110 collectively does not have to provide the information to the communication control apparatus 130A. The provision of information by the communication apparatus 110 or the intermediate apparatus to the communication control apparatus 130 or 130A is merely a method for providing information in the present embodiment. The information listed so far means information that can be necessary for the communication control apparatus 130 to complete the procedure normally, and the method for providing the information is not limited. For example, such a method is called multi-step registration and allowed in WINNF-TS-0061.

Further, of course, the information listed so far is selectively applicable according to the local legal system and the technical specifications.

### <2. 1. 1. 1 Supplement Regarding Necessary Parameters>

In the registration procedure, it is assumed that, in some cases, there is a need to register, with the communication control apparatus 130, not only a device parameter related to the communication apparatus 110 but also a device parameter related to the terminal 120. In such a case, the term “communication apparatus” in the description given in <2.1.1> may be replaced with the term “terminal” or an equivalent term and the term “terminal” or the equivalent term may be applied. Further, a “terminal”-specific parameter that is not described in <2.1.1> may also be used as the necessary parameter in the registration procedure. There is, for example, a user equipment (UE) category defined in 3GPP.

### <2.1.2 Details of Registration Processing>

As described above, the communication apparatus 110) representing a wireless system that intends to use a frequency band generates a registration request including a device parameter, and reports the registration request to the communication control apparatus 130.

Here, when the installer information is included in the device parameters, the communication apparatus 110 may perform, for example, an anti-tampering process on the registration request using the installer information. Further, encryption processing may be performed on a portion of or all of the information included in the registration request. Specifically, for example, a specific public key may be shared in advance by the communication apparatus 110 and the communication control apparatus 130, and the communication apparatus 110 may encrypt information using a secret key corresponding to the public key. Examples of an encryption target include security sensitive information such as the position information.

Note that IDs of the communication apparatuses 110 and pieces of position information regarding positions of the communication apparatuses 110 may be disclosed, and the communication control apparatus 130 may hold in advance the ID of the primary communication apparatus 110 situated in the coverage of the communication control apparatus 130, and the position information regarding a position of the primary communication apparatus 110. In such a case, the position information does not have to be included in the registration request since the communication control apparatus 130 can acquire the position information from the ID of the communication apparatus 110 having transmitted the registration request. Further, it is also conceivable that the communication control apparatus 130 could reply by transmitting a necessary device parameter to the communication apparatus 110 having transmitted the registration request, and, in response to receiving the necessary device parameter, the communication apparatus 110 could transmit a registration request including a device parameter necessary for registration. As described above, the information included in the registration request may differ depending on the condition.

After receiving the registration request, the communication control apparatus 130 performs processing of registering the communication apparatus 110, and makes a registration response according to a result of the processing. If there is no lack of information necessary for registration and no anomaly has occurred in the necessary information, the communication control apparatus 130 records the information in an internal or external storage apparatus, and reports a normal completion. Otherwise, a registration failure is reported. When the registration is completed normally, the communication control apparatus 130 may respectively assign IDs to the communication apparatuses 110, and may report information regarding the IDs upon making a response. When the registration fails, the communication apparatus 110 may report a revised registration request again. Further, the communication apparatus 110 may change the registration request and try the registration procedure until the registration is completed normally.

Note that, in some cases, the registration procedure is also performed after registration is completed normally. Specifically, for example, the registration procedure can be performed again when the position information is changed beyond a specified standard due to, for example, movement or improvement in accuracy. Typically, the specified standard is determined by a legal system in each country or region. For example, according to 47 C.F.R. Part 15 in the United States, a Mode II personal/portable white space device, that is, an apparatus using a free spectrum is obliged to perform registration again when the position of the apparatus is changed by 100 meters or more.

### <2.2 Available Spectrum Query Procedure>

An available spectrum query procedure is a procedure performed when a wireless system that intends to use a frequency band inquires of the communication control apparatus 130 about information regarding an available spectrum. Note that the available spectrum query procedure does not necessarily have to be performed. Further, the communication apparatus 110 making inquiries as a representative of a wireless system that intends to use a frequency band may be the same as or different from the communication apparatus 110 having generated a registration request. Typically, the communication apparatus 110 making inquiries reports, to the communication control apparatus 130, an inquiry request including information with which the communication apparatus 110 can be specified, and this results in starting the procedure.

Here, typically, the available spectrum information is information indicating a spectrum with which the communication apparatus 110 can safely perform secondary use without critically interfering with the primary system.

The available spectrum information is determined on the basis of, for example, a secondary use prohibited area called an exclusion zone. Specifically, for example, when the communication apparatus 110 is installed in the secondary use prohibited area provided for the purpose of protecting the primary system, which uses a frequency channel F1, the frequency channel F1 is not reported to the communication apparatus 110 as an available channel.

The available spectrum information can also be determined by, for example, a degree of interference with the primary system. Specifically, when, for example, it is determined that a frequency channel critically interferes with the primary system even if the frequency channel is situated outside of the secondary use prohibited area, the frequency channel is not reported as an available channel in some cases. An example of a specific calculation method will be described in <2.2.2> described later.

Further, there may be a frequency channel that is not reported as an available channel, depending on a condition other than primary system protection requirements, as described above. Specifically, for example, there is a possibility that a frequency channel that is being used by a certain communication apparatus 110 that is situated near another communication apparatus 110 will not be reported as an available channel, in order to avoid interference that may occur between the communication apparatuses 110 in advance. As described above, the available spectrum information set in consideration of interference with another communication apparatus 110 may be set to be, for example, “use recommended spectrum information”, and may be provided together with the available spectrum information. In other words, the “use recommended spectrum information” is desirably a subset of the available spectrum information.

Even when the primary system is affected, a spectrum that is the same as the spectrum of the primary system or the communication apparatus 110 situated nearby may be reported as an available channel if the primary system is not affected by reducing transmission power. In such a case, typically, the available spectrum information includes maximum allowed transmission power information. Typically, the maximum allowed transmission power is expressed by use of EIRP. The maximum allowed transmission power is not necessarily limited thereto, and may be provided by, for example, a combination of conducted power and an antenna gain. Further, an allowed peak gain may be set for the antenna gain for each spatial direction.

### <2.2.1 Details of Necessary Parameters>

For example, unique information registered at the time of the registration procedure, and the ID information described above can be assumed as information with which a wireless system that intends to use a frequency band can be specified.

Further, the inquiry request can also include inquiry requirement information. The inquiry requirement information can include, for example, information indicating a frequency band for which it is desired to know the availability. Furthermore, the inquiry requirement information can also include, for example, the transmission power information. The communication apparatus 110 making inquiry can include the transmission power information in the inquiry request when, for example, it is desired to know only spectrum information regarding a spectrum with which it is likely that desired transmission power can be used. The inquiry requirement information does not necessarily have to be included in the inquiry request.

The information indicating a frequency band can also include information indicating a format of the available spectrum information. In the IEEE 802.11 standard, a channel number is defined for each band. For example, a flag used to request the availability of a channel defined in such wireless interface technical specifications may be included. A flag used to request the availability of a unit spectrum range instead of the defined channel may be included as another format. When the unit spectrum is 1 MHz, the available spectrum information is requested for each spectrum range of 1 MHz. When this flag is used, desired unit spectrum information may be enclosed in the flag.

Further, the inquiry request can also include a measurement report. The measurement report includes results of measurement performed by the communication apparatus 110 and/or the terminal 120. A portion of or all of the measurement results may be represented by raw data, or may be represented by processed data. For example, standardized metrics as represented by reference signal received power (RSRP), a reference signal strength indicator (RSSI), and reference signal received quality (RSRQ) can be used for measurement.

### <2.2.2 Details of Processing of Evaluating Available Spectrum>

After an inquiry request is received, an available spectrum is evaluated on the basis of inquiry requirement information. For example, the available spectrum can be evaluated in consideration of the primary system, a secondary use prohibited area for the primary system, and the presence of the communication apparatus 110, which is situated nearby, as described above.

The communication control apparatus may derive the secondary use prohibited area. When, for example, maximum transmission power P_{MaxTx (dBm)} and minimum transmission power P_{MinTx (dBm)} are defined, the secondary use prohibited area can be determined by calculating, from a formula indicated below, a range of a separation distance between the primary system and the secondary system.

$${{PL}^{- 1} ( {P}_{MaxTx ( dBm )} - {I}_{Tb ( dBm )} )}_{( dB )} \leq d < {{PL}^{- 1} ( {P}_{MinTx ( dBm )} - {I}_{Tb ( dBm )} )}_{( dB )} \qquad [ Math . 2 ]$$

I_{Th (dBm)} is allowable interference power (a limit value of allowable interference power), d is a distance between a specified reference point and the communication apparatus 110, and PL( )_{(dB)} is a function of a propagation loss. Accordingly, the spectrum availability can be determined according to a positional relationship between the primary system and the communication apparatus 110. Further, when transmission power information or power range information desired to be used by the communication apparatus 110 is supplied in a request, the spectrum availability can be determined by calculating PL⁻¹(P_{Tx (dBm)}−I_{Th (dBm)}) and performing comparison with the range formula described above.

The maximum allowed transmission power information may be derived. Typically, the maximum allowed transmission power information is calculated using allowable interference power information regarding allowable interference power in the primary system or a protection zone of the primary system, position information regarding a position of a reference point used to calculate a level of interference power of interference with the primary system, registration information regarding the communication apparatus 110, and a propagation loss estimation model. Specifically, for example, calculation is performed using a formula indicated below.

$$\begin{matrix}[ Math . 3 ] & \\ {P}_{MaxTx ( dBm )} = {I}_{Tb ( dBm )} + {PL ( d )}_{( dB )} & ( 2 )\end{matrix}$$

In Formula (2), an antenna gain in a transceiver is not included. However, the antenna gain in the transceiver may be included according to a method for representing maximum allowed transmission power (such as EIRP or conducted power) or a reference point at which reception power is referred to (such as an antenna input point or an antenna output point). Further, a safety margin or the like used to compensate for a variation caused due to fading may also be included. Furthermore, a feeder loss may be considered as necessary. Moreover, calculation can also be performed similarly for an adjacent channel by taking into consideration an adjacent channel leakage ratio (ACRL) or a maximum value of out-of-band emission.

Further, Formula 2 has been written on the basis of the assumption that a single communication apparatus 110 is an interference source (single station interference). When, for example, there is a need to consider, at the same time, aggregated interference from a plurality of communication apparatuses 110, a correction value may be taken into consideration. Specifically, for example, the correction value can be determined on the basis of three types of interference margin distribution schemes (Fixed/Predetermined, Flexible, Flexible Minimized) disclosed in Non-Patent Literature 8 (ECC Report 186).

Note that the allowable interference power information itself does not necessarily become available directly, as in the case of Formula 2. When, for example, a necessary signal-power-to-interference-power ratio (SIR) or signal-to-interference-plus-noise ratio (SINR) of the primary system is available, such a ratio may be converted into allowable interference power and the obtained allowable interference power may be used. Note that such conversion processing is not limited to this processing, and may also be applied to processing of other procedures.

Note that Formula 2 is expressed using logarithms. However, of course, the logarithmic expression may be converted into an antilogarithmic expression and the obtained antilogarithmic expression is used upon performing practicing. Further, all of parameters in logarithm that are described in the present disclosure may be appropriately converted into parameters in antilogarithm and the obtained parameters in antilogarithm may be used.

Further, when the inquiry requirement information includes the transmission power information described above, an available spectrum can be evaluated using a method that is different from the method described above. Specifically, when, for example, it is assumed that desired transmission power indicated by transmission power information is used and when an estimated interference amount is less than allowable interference power in the primary system or a protection zone of the primary system, the frequency channel is determined to be available, and the determination is reported to the communication apparatus 110.

Further, when, for example, an area or space in which the communication apparatus 110 can use a frequency band is determined in advance, as in the case of an area of a radio environment map (REM), the available spectrum information may be simply derived on the basis of only coordinates (coordinates of an x axis, y axis, and z axis, or latitude, longitude, and height above ground with respect to the communication apparatus 110) included in the position information regarding a position of the communication apparatus 110. Furthermore, when, for example, a lookup table in which coordinates of the position of the communication apparatus 110 are associated with available spectrum information is provided, the available spectrum information described above may be derived on the basis of only the position information regarding a position of the communication apparatus 110. As described above, there are various methods for determining an available spectrum, and the determination method is not limited to the example of the present disclosure.

Further, when the communication control apparatus 130 acquires, as the frequency band information regarding a frequency band supported by the communication apparatus 110, information regarding capability of a band extension technology such as carrier aggregation (CA) or channel bonding, the communication control apparatus 130 may include, for example, an available combination or a recommended combination thereof in the available spectrum information.

Furthermore, when the communication control apparatus 130 acquires information regarding a combination of frequency bands supported by the dual connectivity or the multi-connectivity as the frequency band information regarding a frequency band supported by the communication apparatus 110, the communication control apparatus 130 may include information such as an available spectrum and a recommended spectrum in the available spectrum information for the dual connectivity or the multi-connectivity.

Further, when the available spectrum information is provided for the band extension technology as described above and when imbalance of maximum allowed transmission power occurs among a plurality of frequency channels, the available spectrum information may be provided after maximum allowed transmission power of each frequency channel is adjusted. For example, from the perspective of primary system protection, the maximum allowed transmission power of each frequency channel may be aligned with maximum allowed transmission power of a frequency channel having a low maximum allowed power spectral density (PSD)).

The evaluation of an available spectrum does not necessarily have to be performed after an inquiry request is received. For example, the communication control apparatus 130 may independently perform the evaluation without an inquiry request after the registration procedure described above is completed normally. In such a case, the REM or lookup table described above as an example, or an information table that is analogous to the REM or lookup table may be created.

Further, the radio-wave-use priority such as PAL or GAA may also be evaluated. When, for example, information regarding radio-wave-use priority is included in a registered device parameter or inquiry requirements, whether a spectrum can be used may be determined on the basis of the priority, and the determination may be reported. Furthermore, when, for example, information (referred to as a cluster list in Non-Patent Literature 1) regarding the communication apparatus 110 performing high-priority use (for example, PAL) is registered in advance by a user with the communication control apparatus 130, as disclosed in Non-Patent Literature 1, evaluation may be performed on the basis of the information.

After the evaluation of an available spectrum is completed, the communication control apparatus 130 reports a result of the evaluation to the communication apparatus 110.

The communication apparatus 110 may select a desired communication parameter using the evaluation result received from the communication control apparatus 130. When a spectrum grant procedure described later is not adopted, the communication apparatus 110 may start transmitting radio waves using the selected desired communication parameter as a communication parameter.

### <2.3 Spectrum Grant Procedure>

The spectrum grant procedure is a procedure performed when a wireless system that intends to use a frequency band receives a permission for secondary use of a spectrum from the communication control apparatus 130. The communication apparatus 110 performing the spectrum grant procedure as a representative of the wireless system may be the same as or different from the communication apparatus 110 having performed the procedures so far. Typically, the communication apparatus 110 reports, to the communication control apparatus 130, a spectrum grant request that includes information with which the reporting communication apparatus 110 can be specified, and this results in starting the procedure. Note that the available spectrum query procedure is not indispensable, as described above. Thus, the spectrum grant procedure may be performed subsequently to the available spectrum query procedure, or may be performed subsequently to the registration procedure.

In the present embodiment, it is assumed that at least two types of spectrum grant request schemes indicated below can be used.
designation scheme
flexible scheme

The designation scheme is a request scheme in which the communication apparatus 110 designates a desired communication parameter and requests the communication control apparatus 130 to permit operation based on the desired communication parameter. Examples of the desired communication parameter include a frequency channel desired to be used, and maximum transmission power, although the desired communication parameter is not particularly limited to the examples. For example, a parameter specific to the wireless interface technology (such as a modulation scheme or a duplex mode) may be designated. Further, information indicating radio-wave-use priority such as PAL and GAA may be included.

The flexible scheme is a request scheme in which the communication apparatus 110 only designates a requirement regarding a communication parameter and requests the communication control apparatus 130 to designate a communication parameter that satisfies the requirement and for which secondary use can be permitted. Examples of the requirement regarding a communication parameter include a bandwidth, a desired maximum transmission power, and a desired minimum transmission power, although the requirement regarding a communication parameter is not particularly limited to the examples. For example, a parameter specific to the wireless interface technology (such as a modulation scheme or a duplex mode) may be designated. Specifically, for example, at least one TDD frame structure may be selected in advance and reported.

As in the case of the inquiry request, the spectrum grant request may also include a measurement report. The measurement report includes results of measurement performed by the communication apparatus 110 and/or the terminal 120. The measurement may be represented by raw data, or may be represented by processed data. For example, standardized metrics as represented by reference signal received power (RSRP), a reference signal strength indicator (RSSI), and reference signal received quality (RSRQ) can be used for measurement.

Note that information regarding a scheme used by the communication apparatus 110 may be registered with the communication control apparatus 130 upon the registration procedure described in <2.1>.

### <2.3.1 Details of Spectrum Grant Processing>

After receiving a spectrum grant request, the communication control apparatus 130 performs spectrum grant processing on the basis of a spectrum grant request scheme. For example, the available spectrum grant processing can be performed in consideration of, for example, the primary system, a secondary use prohibited area, and the presence of the communication apparatus 110, which is situated nearby, using the approach described in <2.2>, as described above.

When the flexible scheme is used, maximum allowed transmission power information may be derived using the approach described in <2.2.2>. Typically, the maximum allowed transmission power information is calculated using allowable interference power information regarding allowable interference power in the primary system or a protection zone of the primary system, position information regarding a position of a reference point used to calculate a level of interference power of interference with the primary system, registration information regarding the communication apparatus 110, and a propagation loss estimation model. Specifically, for example, calculation is performed using Formula (2) described above.

Further, Formula 2 has been written on the basis of the assumption that a single communication apparatus 110 is an interference source, as described above. When, for example, there is a need to consider, at the same time, aggregated interference from a plurality of communication apparatuses 110, a correction value may be taken into consideration. Specifically, for example, the correction value can be determined on the basis of the three types of schemes (Fixed/Predetermined, Flexible, Flexible Minimized) disclosed in Non-Patent Literature 8 (ECC Report 186).

The communication control apparatus 130 can use various propagation loss estimation models upon, for example, the spectrum grant procedure and available spectrum evaluation processing performed with respect to an available-spectrum-information-inquiry request. When a model is designated for each application, the designated model is desirably used. For example, Non-Patent Literature 1 (WINNF-TS-0112) discloses that a propagation loss model such as the Extended Hata (eHATA) or the Irregular Terrain Model (ITM) is adopted for each application. Of course, the propagation loss model is not limited thereto.

There are also propagation loss estimation models for which information regarding a radio path is necessary. Examples of the information regarding a radio path can include information indicating being within or outside of a line of sight (a line of sight (LOS) and/or a non line of sight (NLOS)), topographical information (including undulations and height above sea level), and environmental information (including urban, suburban, rural, and open sky). When using a propagation loss estimation model, the communication control apparatus 130 may estimate these pieces of information from already acquired registration information regarding the communication apparatus 110 or already acquired information regarding the primary system. Alternatively, when there is a parameter that is designated in advance, the parameter is desirably used.

When no propagation loss estimation model is designated in a specified application, a model may be selectively used as necessary. For example, the following selective use can be performed: a model, such as a free space loss model, in which a calculated loss is small is used when interference power of interference with another communication apparatus 110 is estimated, and a model in which a calculated loss is large is used when the coverage of the communication apparatus 110 is estimated.

Further, when a designated propagation loss estimation model is used, for example, the spectrum grant processing can be performed by evaluating a risk of interference. Specifically, when, for example, it is assumed that desired transmission power indicated by transmission power information is used and when an estimated interference amount is less than allowable interference power in the primary system or a protection zone of the primary system, it is determined that the use of the frequency channel can be permitted, and the determination is reported to the communication apparatus 110.

In either of the approaches of the designation scheme and the flexible scheme, the radio-wave-use priority such as PAL or GAA may also be evaluated, as in the case of the inquiry request. When, for example, information regarding radio-wave-use priority is included in a registered device parameter or inquiry requirements, whether a spectrum can be used may be determined on the basis of the priority, and the determination may be reported. Further, when, for example, information regarding the communication apparatus 110 performing high-priority use (for example, PAL) is registered in advance by a user with the communication control apparatus 130, evaluation may be performed on the basis of the information. For example, the information regarding the communication apparatus 110 is referred to as a cluster list in Non-Patent Literature 1 (WINNF-TS-0112).

Further, in any of the calculations described above, correction may be performed with respect to the position information regarding a position of the communication apparatus or the coverage using positioning accuracy information (location uncertainty) to determine the spectrum availability when the position information is used.

The spectrum grant processing does not necessarily have to be performed in response to a spectrum grant request being received. For example, the communication control apparatus 130 may independently perform the spectrum grant processing without the spectrum grant request after the registration procedure described above is completed normally. Further, for example, the spectrum grant processing may be performed for each specified period of time. In such a case, the REM or lookup table described above, or an information table that is analogous to the REM or lookup table may be created. This results in determining, only using position information, a spectrum that can be permitted. This enables the communication control apparatus 130 to make a quick response after receiving the spectrum grant request.

### <2.4 Spectrum Use Report/Heartbeat>

A spectrum use report is a procedure in which a wireless system that uses a frequency band reports, to the communication control apparatus 130, a spectrum use based on a communication parameter allowed to be used in the spectrum grant procedure. The communication apparatus 110 performing the spectrum use report as a representative of the wireless system may be the same as or different from the communication apparatus 110 having performed the procedures so far. Typically, the communication apparatus 110 reports, to the communication control apparatus 130, a report message that includes information with which the reporting communication apparatus 110 can be specified.

The spectrum use report is desirably performed periodically until the use of a spectrum is refused by the communication control apparatus 130. In this case, the spectrum use report is also referred to as a heartbeat.

After receiving the spectrum use report, the communication control apparatus 130 may determine whether to start or continue the spectrum use (that is, transmission of radio waves in a permitted spectrum). Examples of the determination method include confirmation of spectrum use information regarding the spectrum use of the primary system. Specifically, it can be determined whether to permit or refuse the start or continuation of the spectrum use (the transmission of radio waves in a permitted spectrum), on the basis of, for example, a change in the use spectrum of the primary system, and a change in a spectrum use state of the primary system in which radio waves are not used steadily (such as a radar on ship in the CBRS in the United States). When the start or continuation is permitted, the communication apparatus 110 may start or continue the spectrum use (the transmission of radio waves in a permitted spectrum).

After receiving the spectrum use report, the communication control apparatus 130 may instruct the communication apparatus 110 to reconfigure communication parameters. Typically, an instruction to reconfigure communication parameters can be given in a response made by the communication control apparatus 130 to the spectrum use report. For example, information regarding recommended communication parameters (hereinafter referred to as recommended-communication-parameter information) can be provided.

The communication apparatus 110 provided with the recommended-communication-parameter information desirably performs the spectrum grant procedure described in <2.4> again using the recommended-communication-parameter information.

### <2.5 Supplement of Various Procedures>

The various procedures described above do not necessarily have to be performed individually. This is described below. For example, two different procedures may be performed by being replaced with a third procedure that serves a function of the two different procedures. Specifically, for example, the registration request and the available-spectrum-information-inquiry request may be reported integrally. Further, for example, the spectrum grant procedure and the spectrum use report may be performed integrally. Of course, without being limited to these combinations, three or more procedures may be performed integrally. Furthermore, a single procedure may be performed at multiple times in a divided manner, as described above.

Further, the expression “acquire” or an expression equivalent thereto in the present disclosure does not necessarily mean acquiring according to the procedures described in the present disclosure. For example, the use of the position information regarding a position of the communication apparatus 110 in the available spectrum evaluation processing, has been described. However, information acquired in the registration procedure does not necessarily have to be used, and position information may be used when an available-spectrum-inquiry-procedure request includes the position information. In other words, the procedure used for acquisition and described in the present disclosure is an example, and acquisition performed by other procedures is also permitted within the scope of the present disclosure and within the scope of technical feasibility.

Further, the information described to be included in a response made by the communication control apparatus 130 to the communication apparatus 110 may be actively reported by the communication control apparatus 130 using a push scheme if possible. As a specific example, the available spectrum information, the recommended-communication-parameter information, and a report about refusal to continue transmission of radio waves may be reported by the push scheme.

### <2. 6 Various Procedures for Terminal>

The description has been primarily made so far on the assumption of the processing performed in the communication apparatus 110A. However, depending on the embodiment, not only the communication apparatus 110A but also the terminal 120 and the communication apparatus 110B can operate under the management of the communication control apparatus 130. In other words, a scenario in which a communication parameter is determined by the communication control apparatus 130 is assumed. In such a case, the respective procedures described in <2.1> to <2.4> can also be used in essence. However, the terminal 120 and the communication apparatus 110B have to use, for a backhaul link, spectra managed by the communication control apparatus 130, and are not allowed to transmit radio waves without permission. This is different from the communication apparatus 110A. Thus, backhaul communication performed in order to access the communication control apparatus 130 is desirably started only after detection of a radio wave or authorization signal transmitted by the communication apparatus 110A (the communication apparatus 110 being capable of providing wireless communication services or a master communication apparatus 110 in a master-secondary system).

On the other hand, allowable communication parameters may also be set for the terminal and communication apparatus 110B being under the management of the communication control apparatus 130, in order to protect the primary system. However, the communication control apparatus 130 does not know, for example, pieces of position information regarding positions of those apparatuses in advance. Further, those apparatuses are more likely to have mobility. In other words, the position information is updated dynamically. Depending on the law, reregistration with the communication control apparatus 130 may be obliged to be performed when there is a change in position information to an extent greater than or equal to a certain extent.

In consideration of, for example, such various modes of use and such various modes of operation for the terminal 120 and the communication apparatus 110, two types of communication parameters indicated below are defined in the mode of operation of the TVWS (Non-Patent Literature 9) defined by the Office of Communications (Ofcom).
generic operational parameters
specific operational parameters

The generic operational parameters are communication parameters defined in Non-Patent Literature 9 as “parameters that can be used by any slave WSD situated in a coverage area of a specified master WSD (corresponding to the communication apparatus 110)”. The generic operational parameters are characterized in being calculated using a WSDB without using position information regarding a position of a slave WSD.

The generic operational parameters can be provided, through unicast or broadcast, by the communication apparatus 110 having been permitted by the communication control apparatus 130 to transmit radio waves. For example, a broadcast signal as represented by a contact verification signal (CVS) defined in Part 15 Subpart H of the FCC Rules in the United States can be used. Alternatively, the generic operational parameters may be provided by a broadcast signal specific to a wireless interface. This enables the generic operational parameters to be used by the terminal 120 and the communication apparatus 110B as communication parameters used to transmit radio waves in order to access the communication control apparatus 130.

The specific operational parameters are communication parameters defined in Non-Patent Literature 9 as “parameters that can be used by a specific slave white space device (WSD)”. In other words, the specific operational parameters are communication parameters calculated using device parameters for a slave WSD corresponding to the terminal 120. The specific operational parameters are characterized in being calculated using a white space database (WSDB) by use of position information regarding a position of a slave WSD.

The CPE-CBSD Handshake Procedure defined in Non-Patent Literature 7 can be considered another mode of procedure related to the terminal. The CPE-CBSD does not have a wired backhaul link, and accesses the Internet via the BTS-CBSD. Thus, permission for transmitting radio waves is not allowed to be acquired in the CBRS band from an SAS without special regulations or procedures. The CPE-CBSD Handshake Procedure allows a CPE-CBSD to transmit radio waves at a minimum necessary duty cycle with the same maximum EIRP as the terminal (EUD) until the permission for transmitting radio waves is acquired from the SAS. Accordingly, the communication apparatus 110B sets a transmission EIRP to a maximum EIRP of the terminal, and communicates with the communication apparatus 110A wirelessly at a minimum necessary duty cycle. This enables the communication apparatus 110B to establish a link used to acquire permission for transmitting radio waves. After the permission for transmitting radio waves is acquired, the communication apparatus 110B can use up to a maximum EIRP determined for the communication apparatus within the scope of permission.

### <2.7 Procedure Occurring Between Communication Control Apparatuses>

### <2. 7.1 Information Exchange>

The communication control apparatus 130 can exchange management information with another communication control apparatus 130. At least information indicated below is desirably exchanged.
information related to communication apparatus 110
area information
protection-target-system information

The information related to the communication apparatus 110 may include at least registration information regarding the communication apparatus 110, which is operating by permission of the communication control apparatus 130, and communication parameter information regarding a communication parameter for the communication apparatus 110, which is operating by permission of the communication control apparatus 130. The information related to the communication apparatus 110 may include the registration information regarding the communication apparatus 110 not having a permitted communication parameter.

Typically, the registration information regarding the communication apparatus 110 is a device parameter for the communication apparatus 110 that is registered with the communication control apparatus 130 in the registration procedure described above. Not all of the registered information necessarily has to be exchanged. For example, there is no need to exchange information that may correspond to personal information. Further, upon exchanging the registration information regarding the communication apparatus 110, the registration information may be encrypted to be exchanged, or the registration information may be exchanged after contents of the information are made unclear. For example, information converted into a binary value or information signed using a system of an electronic signature may be exchanged.

Typically, the communication parameter information regarding a communication parameter for the communication apparatus 110 is information related to a communication parameter that is currently being used by the communication apparatus 110. The communication parameter information desirably includes at least information indicating a used spectrum and transmission power. The communication parameter information may include other communication parameters.

Typically, the area information is information indicating a specified geographical region. This information can include pieces of region information regarding regions of various attributes in various aspects.

For example, the area information may include protection area information regarding the communication apparatus 110 corresponding to a high-priority secondary system, such as a PAL protection area (PPA) disclosed in Non-Patent Literature 1 (WINNF-TS-0112). The area information in this case can be represented by, for example, at least three sets of coordinates representing geographical positions. Further, when, for example, a plurality of communication control apparatuses 130 can refer to a shared external database, the area information can be represented by a unique ID, and an actual geographical region can be referred to from the external database using the ID.

Further, the area information may include, for example, information indicating the coverage of the communication apparatus 110. The area information in this case can also be represented by, for example, at least three sets of coordinates representing geographical positions. Furthermore, for example, the area information can also be represented by information indicating a radius size on the assumption that the coverage corresponds to a circle centered at a geographical position of the communication apparatus 110. Further, when, for example, a plurality of communication control apparatuses 130 can refer to a shared external database that records therein the area information, the information indicating the coverage can be represented by a unique ID, and an actual coverage can be referred to from the external database using the ID.

Further, as another aspect, the area information can also include information related to an area block determined by, for example, a government in advance. Specifically, for example, certain region can be indicated by giving an address. Furthermore, for example, a license area can be indicated similarly.

Furthermore, as yet another aspect, the area information does not necessarily indicate a planar area, and may indicate a three-dimensional space. For example, the area information may be represented using a spatial coordinate system. Further, for example, information indicating a specified closed space, such as a floor number, a floor, and a room number in a building may be used.

For example, the protection-target-system information is information regarding a wireless system, such as the incumbent tier described above, that is treated as a protection target. Examples of a state in which there is a need to exchange this information include a state in which there is a need for cross-border coordination. It is quite conceivable that there could be different protection targets in a single band in neighboring countries or regions. In such a case, pieces of protection-target-system information can be exchanged as necessary between the communication control apparatuses 130 belonging to different countries or regions.

As another aspect, the protection-target-system information can include information regarding a secondary licensee and information regarding a wireless system operated by the secondary licensee. Specifically, the secondary licensee is a lessee of a license, and it is assumed that, for example, the secondary licensee leases a PAL from a holder of the PAL and operates a wireless system of the secondary licensee. When the communication control apparatus 130 manages the leasing independently, pieces of information regarding secondary licensees and pieces of information regarding wireless systems operated by the secondary licensees can be exchanged with another communication control apparatus for the purpose of protection.

These pieces of information can be exchanged between the communication control apparatuses 130 regardless of a decision-making topology applied to the communication control apparatus 130.

Further, these pieces of information can be exchanged in various schemes. The following are examples of the schemes.
ID designation scheme
time-period designation scheme
region designation scheme
dumping scheme

The ID designation scheme is a scheme in which an ID that is provided in advance to specify information managed by the communication control apparatus 130 is used to acquire information corresponding to the ID. It is assumed that, for example, a first communication control apparatus 130 manages the communication apparatus 110 having an ID of AAA. Here, a second communication control apparatus 130 designates the ID of AAA to make an information acquisition request to the first communication control apparatus 130. After receiving the request, the first communication control apparatus 130 searches for information regarding the ID of AAA, and reports, in the form of a response, information regarding the communication apparatus 110 having the ID of AAA, such as registration information and communication parameter information.

The time-period designation scheme is a scheme in which information that satisfies a specified condition for a designated specific period of time can be exchanged.

Examples of the specified condition include whether information is updated. When, for example, a request that information regarding the communication apparatus 110 for a specific period of time be acquired is made, registration information regarding the communication apparatus 110 newly registered for the specific period of time can be reported in the form of a response. Further, registration information regarding the communication apparatus 110 for which there has been a change in communication parameter for the specific period of time, or information regarding a communication parameter for the communication apparatus 110 for which there has been a change in communication parameter for the specific period of time can also be reported in the form of a response.

Examples of the specified condition include whether recording has been performed by the communication control apparatus 130. When, for example, a request that information regarding the communication apparatus 110 for a specific period of time be acquired is made, registration information or communication parameter information that has been recorded by the communication control apparatus 130 can be reported in the form of a response. When information is updated for the period of time, latest information for the period of time can be reported. Alternatively, an update history can be reported for each piece of the information.

In the region designation scheme, a specific region is designated, and information regarding the communication apparatus 110 belonging to the region is exchanged. When, for example, a request that information regarding the communication apparatus 110 in a specific region be acquired is made, registration information regarding the communication apparatus 110 installed in the region, or information regarding a communication parameter for the communication apparatus 110 installed in the region can be reported in the form of a response.

The dumping scheme is a scheme of providing all of the information recorded by the communication control apparatus 130. At least information related to the communication apparatus 110 and area information are desirably provided using the dumping scheme.

The information exchange performed between the communication control apparatuses 130 has been described so far on the basis of only a pull scheme. In other words, the pull scheme corresponds to an aspect in which information corresponding to a parameter designated in a request is returned by making a response, and can be provided using the HTTP GET method. However, information is not limited to being provided using the pull scheme, and information may be provided actively to another communication control apparatus 130 using a push scheme. For example, the push scheme can be provided by the HTTP POST method.

### <2.7.2 Instruction or Request Procedure>

The communication control apparatuses 130 may mutually give an instruction or make a request. Specifically, the reconfiguration of a communication parameter for the communication apparatus 110 is an example of the mutual instruction or request. When, for example, it is determined that a first communication apparatus 110 managed by a first communication control apparatus 130 is greatly interfered with by a second communication apparatus 110 managed by a second communication control apparatus 130, the first communication control apparatus 130 may request the second communication control apparatus 130 to change a communication parameter for the second communication apparatus 110.

The reconfiguration of area information is another example of the mutual instruction or request. When, for example, coverage information or protection area information regarding the second communication control apparatus 130 managed by the second communication apparatus 110 is calculated inadequately, the first communication control apparatus 130 may request the second communication control apparatus 130 to reconfigure the area information. A request to reconfigure area information may be made for various reasons besides the reasons described above.

### <2.8 Information Transmission Method>

The above-described reporting (signaling) between entities can be performed through various media. E-UTRA or 5G NR is described as an example. Of course, the reporting is performed without being limited thereto.

### <2. 8. 2 Signaling Between Communication Control Apparatus 130 and Communication Apparatus 110>

Reporting from the communication apparatus 110 to the communication control apparatus 130 may be performed in, for example, an application layer. For example, the reporting may be performed using a hypertext transfer protocol (HTTP). Signaling can be performed by describing a necessary parameter in a message body of an HTTP according to a specified way. Further, when an HTTP is used, reporting from the communication control apparatus 130 to the communication apparatus 110 is also performed according to a system of responding using an HTTP.

### <2. 8. 3 Signaling Between Communication Apparatus 110 and Terminal 120>

Reporting from the communication apparatus 110 to the terminal 120 may be performed using, for example, at least one of radio resource control (RRC) signaling, system information (SI), or downlink control information (DCI). Further, examples of a downlink physical channel include a physical downlink control channel (PDCCH), a physical downlink shared channel (PDSCH), a physical broadcast channel (PBCH), an NR-PDCCH, an NR-PDSCH, and an NR-PBCH. The reporting may be performed using at least one of them.

Reporting from the terminal 120 to the communication apparatus 110 may be performed using, for example, radio resource control (RRC) signaling or uplink control information (UCI). Further, the reporting may be performed using an uplink physical channel (a physical uplink control channel (PUCCH), a physical uplink shared channel (PUSCH), or a physical random access channel (PRACH)).

Without being limited to the physical layer signaling described above, signaling may be performed in a higher layer. When, for example, signaling is performed in the application layer, signaling may be performed by describing a necessary parameter in a message body of an HTTP according to a specified way.

### <2. 8. 4 Signaling Between Terminals 120>

FIG. 6 illustrates an example of a flow of signaling when device-to-device (D2D) or vehicle-to-everything (V2X), which corresponds to communication between the terminals 120, is assumed to be performed as communication performed in the secondary system. The D2D or V2X, which corresponds to communication between the terminals 120, may be performed using a physical sidelink channel (a physical sidelink control channel (PSCCH), a physical sidelink shared channel (PSSCH), or a physical sidelink broadcast channel (PSBCH)). The communication control apparatus 130 calculates a communication parameter that is to be used by the secondary system (T101) and reports the calculated communication parameter to the communication apparatus 110 of the secondary system (T102). The communication parameter may be reported after a value of the communication parameter is determined, or the communication parameter may be reported after a condition indicating, for example, a range of the communication parameter is determined. The communication apparatus 110 acquires the communication parameter that is to be used by the secondary system (T103), and sets the communication parameter that is to be used by the communication apparatus 110 itself (T104). Then, the communication parameter that is to be used by the terminal 120 subordinate to the communication apparatus 110 is reported to the terminal 120 (T105). Each of the terminals 120 subordinate to the communication apparatus 110 acquires (T106) and sets (T107) the communication parameter that is to be used by the terminal 120. Then, communication with another terminal 120 of the secondary system is performed (T108).

A communication parameter used when a target frequency channel that is a target for spectrum sharing is used in a sidelink (direct communication between the terminals 120) may be reported, acquired, or set in a state of being associated with a sidelink resource pool in the target frequency channel. The resource pool is a sidelink radio resource that is set by a specific frequency resource or temporal resource. Examples of the frequency resource include a resource block and a component carrier. Examples of the temporal resource include a radio frame, a subframe, a slot, and a mini-slot. When a resource pool is set in a frequency channel that is a target for spectrum sharing, the resource pool is set for the terminal 120 by the communication apparatus 110 on the basis of at least one of RRC signaling, system information, or downlink control information. Then, a communication parameter that is to be applied in the resource pool and the sidelink is also set for the terminal 120 by the communication apparatus 110 on the basis of at least one of RRC signaling, system information, or downlink control information. Setting of a resource pool and a communication parameter that is to be used in a sidelink may be reported simultaneously or separately.

### 3. Embodiments of Present Disclosure

In the present embodiment, it is assumed that a PAL holding operator serving as a lessor leases, to at least one lessee, a PAL that corresponds to a right to use (a secondary use) a spectrum of radio waves preferentially in the CBRS, and that both the lessor and the lessee use the spectrum with the respective communication apparatuses (CBSDs). For example, the lessor has made, at auction, a successful bid for a PAL that corresponds to a right to use a certain spectrum preferentially in a county that corresponds to a license area, and holds the PAL. The lessor leases the PAL to at least one lessee in the county (that is, one license area). Leasing ranges (geographical regions) for the respective lessees are different from each other in the county, and a range in which the lessor uses the spectrum after the leasing has been performed is also different from each of the leasing ranges.

A communication control apparatus (an SAS) that manages a CBSD of the lessor and a CBSD of each lessee calculates a PAL protection area (PPA) for the CBSD of the lessee having the PAL, on the basis of the equivalent-isotropic-radiated-power (EIRP) capability of the CBSD of the lessee. The PPA is an area in which a CBSD is protected from external radio-wave interference. Likewise, the SAS also calculates a PPA for the CBSD of the lessor. In cooperative periodic activities among SASs (CPAS) that are performed by the SAS in cooperation with another SAS, a process called an iterative allocation process (IAP) is performed to determine a maximum allowed transmission power of each CBSD such that the CBSD is externally protected from radio-wave interference in the PPA. In particular, a maximum allowed transmission power for which permission is given to each CBSD is determined for a PAL grant issued by the SAS when the SAS permits the CBSD to use a spectrum. Alternatively, for example, the maximum allowed transmission power may be determined using the above-described spectrum permission procedure in which a PAL grant is issued, or using the above-described spectrum-use-report procedure in which the use of an issued PAL grant is reported. Each CBSD performs transmission with transmission power that is less than or equal to the determined maximum allowed transmission power. As a result, one of the CBSDs of the lessor and the lessee is protected from being interfered with by another of the CBSDs of the lessor and the lessee. Further, the CBSDs of the lessor and the lessee are protected from being interfered with by yet another CBSD (also including a CBSD managed by another SAS or a CBSD having a general authorized access (GAA) grant).

The present embodiment provides a system that prevents or reduces a reduction in a maximum allowed transmission power for a desired PAL grant when a maximum allowed transmission power for a PAL grant for a CBSD of the lessor or for a PAL grant for a CBSD of the lesser is determined by an IAP being performed. An IAP for which this system has been introduced is referred to as an IAP according to the present embodiment. A conventional IAP before the system is introduced is referred to as a usual IAP. This makes it possible to, for example, avoid reducing a maximum allowed transmission power of a communication apparatus of the lessor or the lessee while sufficiently securing a leasable range adopted when a right (a PAL) to use a spectrum of radio waves preferentially is leased. The present embodiment is described in detail below.

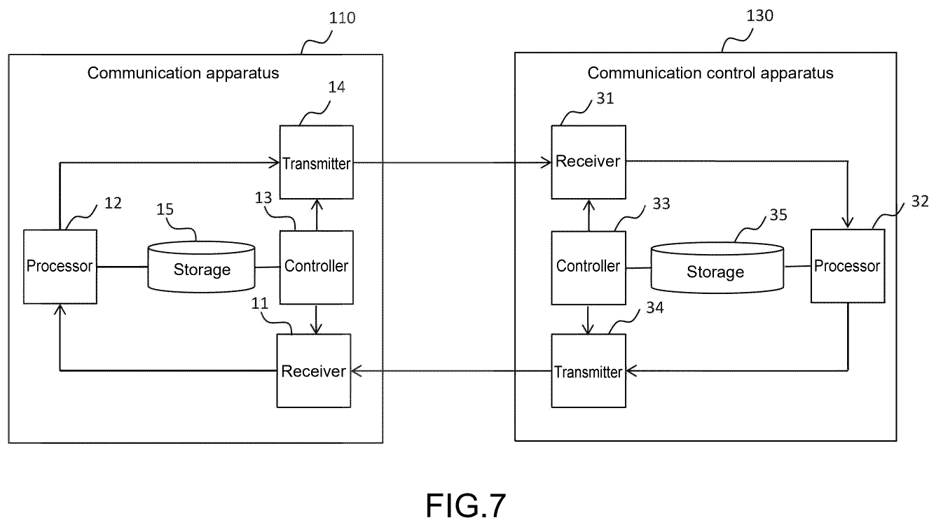

First, basic configurations of a communication control apparatus (an SAS) and a communication apparatus (a CBSD) are described below with reference to FIG. 7, and thereafter, processing performed by the communication control apparatus (the SAS) is described in detail.

FIG. 7 is a block diagram of a communication system according to the present embodiment. The communication system illustrated in FIG. 7 includes the communication apparatus 110, and the communication control apparatus 130 managing the communication apparatus 110. In the present embodiment, the communication apparatus 110 corresponds to a CBSD, and the communication control apparatus 130 corresponds to an SAS. The figure only illustrates a single communication apparatus 110. However, actually, there is a plurality of communication apparatuses, and the plurality of communication apparatuses is managed by the communication control apparatus 130. Further, the figure only illustrates a single communication control apparatus 130. However, actually, there is also another communication control apparatus. The other communication control apparatus manages a plurality of communication apparatuses different from the plurality of communication apparatuses managed by the communication control apparatus 130.

### (Communication Control Apparatus 130)

The communication control apparatus 130 includes a receiver 31, a processor 32, a controller 33, a transmitter 34, and a storage 35. The transmitter 34 and the receiver 31 each include at least one antenna.

The transmitter 34 performs processing of transmitting a signal to the communication apparatus 110 and another communication control apparatus 130 wirelessly or by wire.

The receiver 31 performs processing of receiving a signal from the communication apparatus 110 and another communication control apparatus 130 wirelessly or by wire.

The controller 33 controls each structural element included in the communication control apparatus 130 to control the entirety of the communication control apparatus 130.

The storage 35 of the communication control apparatus 130 stores therein in advance various information necessary to communicate with the communication apparatus 110 and another communication control apparatus 130. For example, the storage 35 stores therein information regarding a registered communication apparatus 110. Examples of the information include an ID, position information, maximum-transmission-power information (such as a value of EIRP capability and a maximum conducted power), dynamic-beam-pattern information (information regarding a movable range of a beam), and information regarding antenna transmission power (conducted power) with respect to the communication apparatus 110. Further, the storage 35 stores therein information regarding a PAL grant issued by the communication control apparatus 130 to the communication apparatus 110. Examples of the information regarding a PAL grant include an ID of the PAL grant, a spectrum permitted to be used by the communication apparatus 110, a maximum allowed transmission power, and a beam pattern.

The processor 32 performs various processes according to the present embodiment. For example, the processor 32 performs, together with a CBSD, processing related to a registration procedure, a spectrum use inquiry procedure, and a spectrum grant procedure.

Further, the processor 32 calculates a PPA in response to a request being made by a CBSD, and transmits a result of the calculation of the PPA to the CBSD.

Furthermore, the processor 32 performs a process called coordinated periodic activities among SASs (CPAS) together with at least one another communication control apparatus. The CPAS is processing performed by a plurality of SASs once every 24 hours, where a calculation process related to protection of a higher tier such as Incumbent (a protection-target system or the primary system), and a calculation process related to PPA protection are performed.

In addition to the calculation process related to PPA protection, the processor 32 also performs a process of determining a maximum allowed transmission power of the communication apparatus 110 (a CBSD) using the above-described IAP according to the present embodiment. This process results in determining an allowed transmission power of each CBSD, where each of interference with another CBSD and interference with Incumbent from the CBSD is less than or equal to an allowance value with the allowed transmission power. The interference with the other CBSD and interference with Incumbent each being less than or equal to the allowance value means that, for example, an amount of interference with an optional protection point related to each of the other CBSD and Incumbent is less than or equal to an allowance value. Examples of the optional protection point include at least one protection point set in a PPA for the other CBSD, and at least one protection point set for Incumbent.

The usual IAP is an approach in which transmission power of a CBSD is repeatedly reduced by a fixed amount (a reduction amount) for each protection point until an amount of cumulative interference with the protection point is less than or equal to a threshold (an allowance value), and interference margin (interference allowance power) for each protection point is distributed to a corresponding CBSD. This makes it possible to determine transmission power of each CBSD such that the transmission power exhibits a power value with which cumulative interference power of cumulative interference with each protection point from the CBSD is less than or equal to the allowance value.

In this regard, the IAP according to the present embodiment is similar to the usual IAP. However, in the IAP according to the present embodiment, a high-priority CBSD is excluded from a calculation target for calculation performed in the IAP with respect to a PPA for a low-priority CBSD, on the basis of a priority relationship between CBSDs in interference protection. In other words, when the IAP is performed with respect to a PPA for a low-priority CBSD, an amount of a reduction in transmission power of a high-priority CBSD is set to zero. This results in avoiding reducing the transmission power of the high-priority CBSD. Accordingly, the high-priority CBSD can keep a higher allowed transmission power than the low-priority CBSD. Note that an initial value of transmission power may be transmission power desired by a CBSD, or may be a current transmission power of the CBSD when a grant has been given to the CBSD.

The processor 32 may acquire information indicating a priority relationship between the respective communication apparatuses 110 of the lessor and the lessee by setting the priority relationship on the basis of contract information regarding a contract between the lessor and the lessee. Alternatively, the processor 32 may acquire the information indicating the priority relationship between the communication apparatuses 110 from an external database. The information indicating the priority relationship may be in any form. For example, the information indicating the priority relationship may be a description indicating that the lessor is given a higher priority than the lessee (the lessor has priority over the lessee) (for example, “lessor > lessee”), or a level of priority given to each CBSD may be represented by a numerical value, such as setting the level of priority of a CBSD of the lessor to “1” and setting the level of priority of a CBSD of the lessee to “2”.

The processor 32 reports information indicating a determined allowed transmission power to the communication apparatus 110 (a CBSD) together with information regarding an available spectrum in a state in which the pieces of information are associated with a PAL grant. Examples of a timing of reporting the information can include a timing of making a response to the communication apparatus 110 about an available spectrum procedure, a timing of transmitting a response upon performing the spectrum grant procedure, and any other timings.

Each processing block of the communication control apparatus 130 is implemented by a hardware circuit, software (such as a program), or both the hardware circuit and the software. The storage 35 is any storage apparatus such as a memory apparatus, a magnetic storage apparatus, or an optical disk. Instead of being included in the communication control apparatus 130, the storage 35 may be externally connected to the communication control apparatus 130 by wire or wirelessly. Each of the transmitter 34 and the receiver 31 in the communication control apparatus 130 may include at least one network interface according to the number of or the type of connectable networks.

### (Communication Apparatus 110)

The communication apparatus 110 includes a receiver 11, a processor 12, a controller 13, a transmitter 14, and a storage 15. The transmitter 14 and the receiver 11 each include at least one antenna.

The transmitter 14 performs processing of transmitting a signal to the communication control apparatus 130 and another communication apparatus 110 wirelessly or by wire. Further, the transmitter 14 performs processing of transmitting a signal wirelessly or by wire to the terminal 120 situated in a cell of the communication apparatus 110.

The receiver 11 performs processing of receiving a signal from the communication control apparatus 130 or another communication apparatus 110 wirelessly or by wire. Further, the receiver 11 performs processing of receiving a signal wirelessly or by wire from the terminal 120 situated in the cell of the communication apparatus 110.

The controller 13 controls each structural element included in the communication apparatus 110 to control the entirety of the communication apparatus 110. For example, the controller 13 may control beam forming of the transmitter 14 or beam forming of the receiver 11.

The storage 15 of the communication apparatus 110 stores therein in advance various information necessary to communicate with, for example, the communication control apparatus 130 or another communication apparatus 110. Further, the storage 15 stores therein information regarding, for example, various capabilities and specifications of the communication apparatus 110. For example, the storage 15 stores therein an ID, position information, maximum-transmission-power information (such as a value of EIRP capability and a maximum conducted power), dynamic-beam-pattern information (information regarding a movable range of a beam), and information regarding antenna transmission power (conducted power) with respect to the communication apparatus 110.

The processor 12 performs various processes according to the present embodiment. For example, the processor 12 performs, together with the communication control apparatus 130, processing related to the various procedures described above, such as the registration procedure, the spectrum use inquiry procedure, or the spectrum grant procedure.

Each processing block of the communication apparatus 110 is implemented by a hardware circuit, software (such as a program), or both the hardware circuit and the software. The storage 15 is any storage apparatus such as a memory apparatus, a magnetic storage apparatus, or an optical disk. Instead of being included in the communication apparatus 110, the storage 15 may be externally connected to the communication apparatus 110 by wire or wirelessly. Each of the transmitter 14 and the receiver 11 in the communication apparatus 110 may include at least one network interface according to the number of or the type of connectable networks.

Processing performed to reduce a reduction in an allowed transmission power of a high-priority CBSD when the SAS 130 determines an allowed transmission power for a PAL grant for each CBSD upon performing an IAP, is described below.

### <3.1 When Level of Priority is Determined for Lessor and Lessee in One License Area>

In the following description, it is assumed that a lessor A (an operator A) leases a PAL held by the lessor A in a county to other lessees that are a lessee B (an operator B) and a lessee C (an operator C), and that the lessor and the lessees each install a CBSD. The CBSDs installed by the lessor A, the lessee B, and the lessee C are respectively referred to as a CBSD_A, a CBSD_B, and a CBSD_C. The county is an example of a unit of area assigned a PAL.

When a PAL is leased to the lessees B and C, each of the processors 12 of the CBSDs of the lessees B and C registers, with a Spectrum Access System (SAS) and using the registration procedure, various information such as position information regarding a position of the CBSD and the equivalent isotropic radiated power (EIRP) capability of the CBSD on the basis of the leased PAL.

The processor 32 of the SAS 130 calculates, for each PAL CBSD, a PPA based on the registered EIRP capability in accordance with the method disclosed in R2-SGN-04 in Non-Patent Literature 1. The PPAs calculated for the CBSD_A, the CBSD_B, and the CBSD_C are respectively referred to as a PPA_A, a PPA_B, and a PPA_C.

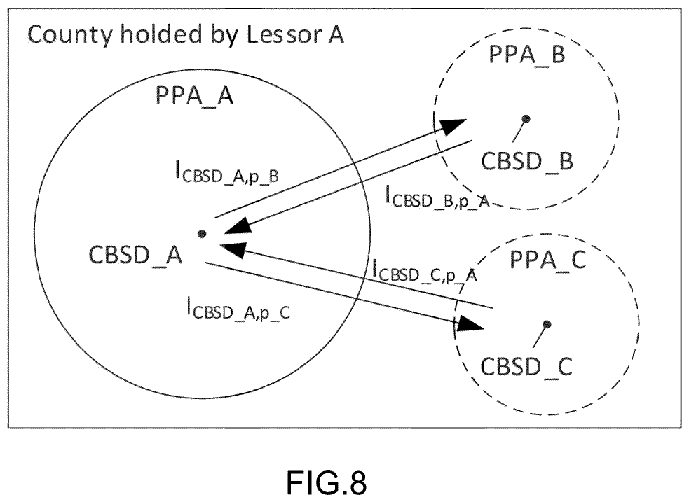

FIG. 8 schematically illustrates the PPA_A, the PPA_B, and the PPA_C as well as interference considered between the lessor A and each of the lessees B and C in a county in which the lessor A has a PAL for a certain spectrum. Here, a description of interference caused between the lessees is omitted. A two-dimensional PPA is assumed in the example illustrated in FIG. 8. However, a three-dimensional PPA may be adopted.

The SAS 130 managing the PPA_A, the PPA_B, and the PPA_C determines an allowed transmission power of each of the CBSD_A, the CBSD_B, and the CBSD_C by performing the IAP according to the present embodiment in CPAS performed together with another SAS, in order to protect the PPA_A, the PPA_B, and the PPA_C. The IAP according to the present embodiment corresponds to an IAP obtained by partially expanding the usual IAP disclosed in R2-SGN-16 in Non-Patent Literature 1.

In the usual IAP disclosed in R2-SGN-16 in Non-Patent Literature 1, it is confirmed whether cumulative interference power of cumulative interference from a CBSD having another grant is less than or equal to an allowance value at 95% or more of at least one calculation point (protection point) set in each PPA and whether a current transmission power of the CBSD that is based on the other grant is allowable. When the current transmission power of the CBSD is not allowable, an amount of a reduction in the transmission power is determined, and information indicating the reduction amount or the reduced transmission power is reported to the CBSD having the other grant. The CBSD can reacquire a grant from the SAS on the basis of the reported information.

A processing flow of the usual IAP is described in detail.

In the IAP, transmission power

$${P}_{n ( dBm )}^{′}$$

of a CBSD (a communication apparatus) n is calculated such that cumulative interference power at a protection point can satisfy a condition in (3) indicated below at all of at least one calculation point.

$$\begin{matrix}[ Math . 4 ] & \\ {I}_{accept ( dBm )} \geq 10 \cdot log \{ {\sum }_{n = 1}^{{N}_{p}} {10}^{\frac{{I}_{n \to p ( dBm )}}{10}} \} & ( 3 )\end{matrix}$$

Here, I_{accept (dBm)} is a threshold of interference power (cumulative interference power) that can be allowed by the primary system.

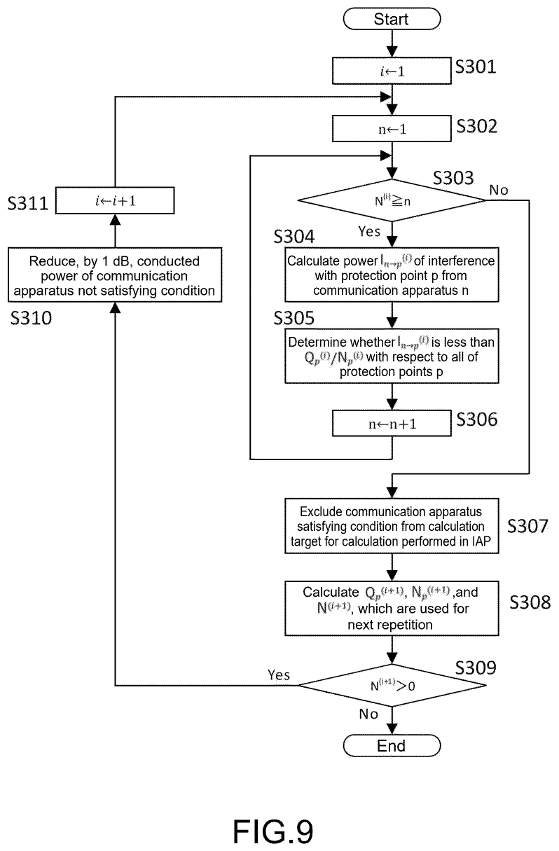

FIG. 9 is a flowchart of processing performed to obtain, using the IAP, the transmission power

$${P}_{n ( dBm )}^{′}$$

allowed to the communication apparatus n on the assumption that the condition in Formula (3) is satisfied. Note that the number of times the IAP is repeated is hereinafter represented by i (i ≥1).

First, the repetition number i of times is set to one (S301). A communication apparatus that is a calculation target for calculation performed in the IAP with respect to one of calculation points (protection points) p is represented by n (1≤n≤N⁽ⁱ⁾). N⁽ⁱ⁾ is a total number of communication apparatuses that are calculation targets when the repetition number of times is i, where the calculation targets are targets for calculation performed in the IAP with respect to at least one calculation point. n is set to 1, and interference power of interference with each calculation point p from the communication apparatus n is calculated (S302, S303, S304).

The interference power

$${I}_{n \to p ( dBm )}^{( i )}$$

of interference with the calculation point p when the number of times the IAP is repeated is i, can be represented by Formula (4) indicated below.

$$\begin{matrix}[ Math . 5 ] & \\ {I}_{n \to p ( dBm )}^{( i )} = {P}_{n ( dBm )}^{( i )} + {{G}_{n} ( {ϕ}_{n \to p} , {θ}_{n \to p} )}_{( dB )} - {L}_{n \to p ( dB )} + {{G}_{PS} ( {ϕ}_{p \to n} , {θ}_{p \to n} )}_{( dB )} & ( 4 )\end{matrix}$$

$${P}_{n ( dBm )}^{( i )}$$

represents conducted power of the communication apparatus n that is set when the number of times the IAP is repeated is i. Note that an initial value

$${P}_{n ( dBm )}^{( 1 )} of {P}_{n}^{( i )}$$

may be a desired conducted power for which the communication apparatus 110 makes a request to the communication control apparatus 130.

Next, it is determined whether interference from the communication apparatus n exhibits a value less than or equal to an allowance value with respect to all of the calculation points p (S305). Here, a total amount

$${Q}_{p ( dBm )}^{( i )}$$

of interference margin with respect to a calculation point p at which there is a communication apparatus that is not assigned interference margin when the repetition number of times is i, is divided by the number

$${N}_{p}^{( i )}$$

of communication apparatuses for which calculation of interference with the calculation point p is necessary, and an obtained value is set to be an allowance value of interference power of interference with the calculation point p for each of the communication apparatuses. Thus, it is determined, in Step S305, whether a condition in (5) indicated below is satisfied with respect to all of the calculation points p.

$$\begin{matrix}[ Math . 6 ] & \\ {I}_{n \to p ( dBm )}^{( i )} < 10 \cdot log \{ {10}^{\frac{{Q}_{p ( dBm )}^{( i )}}{10}} / {N}_{p}^{( i )} \} & ( 5 )\end{matrix}$$

Note that an initial value

$${Q}_{p ( dBm )}^{( 1 )}$$

of a total amount of unassigned interference margin may be I_{accept (dBm)}, and an initial value

$${N}_{p}^{( 1 )}$$

of the number of communication apparatuses 110 for which calculation of interference with the calculation point p is necessary may be Nₚ.

The processes of Steps S304 and S305 described above are performed with respect to all of N⁽ⁱ⁾ communication apparatuses 110. In other words, the processes of Steps S304 and S305 are performed with respect to all of the communication apparatuses n for each number from 1 to N⁽ⁱ⁾ in this order (S303, S306).

From the next repetition, the communication apparatus n satisfying the condition in (5) with respect to all of the calculation points p is excluded from a calculation target for calculation performed in the IAP (S307). Note that a maximum conducted power

$${P}_{n ( dBm )}^{( i )}$$

set for the communication apparatus n at the time of the exclusion is a maximum conducted power

$${P}_{n ( dBm )}^{′}$$

allowed to the communication apparatus n.

Then, the interference power

$${I}_{n \to p ( dBm )}^{( i )}$$

is summed with respect to all of the communication apparatuses excluded from the calculation target, and a value obtained by the summing is subtracted from a total amount

$${Q}_{p}^{( ì )}$$

of interference margin to calculate a total amount

$${Q}_{p ( dBm )}^{( i + 1 )}$$

of interference margin for a next (i+1)-th repetition (S308).

Further, the number of communication apparatuses that are from among

$${N}_{p}^{( i )}$$

communication apparatuses for which calculation of interference with the calculation point p is necessary and that do not satisfy the condition in (5), is set to be the number

$${N}_{p}^{( i + 1 )}$$

of communication apparatuses for which the interference calculation is necessary for the next (i+1)-th repetition (S308).

Further, a total number N⁽ⁱ⁺¹⁾ of communication apparatuses that are calculation targets when the repetition number of times is i+1 is calculated, where the calculation targets are targets for calculation performed in the IAP with respect to one of at least one calculation point (S308).

When a communication apparatus that does not satisfy the condition in (5) remains for one of at least one calculation point p (protection point), that is, when N⁽ⁱ⁺¹⁾>0 (Yes in S309), the conducted power of the communication apparatus not satisfying the condition is reduced by 1 dB (S310), and conducted power obtained by the reduction is used for the next (i+1)-th repetition (S311). In other words, the conducted power used for the (i+1)-th repetition can be represented by a formula indicated below.

$${P}_{n ( dBm )}^{( i + 1 )} = {P}_{n ( dBm )}^{( i )} - 1$$

The IAP is performed repeatedly until all of the communication apparatuses satisfy the condition in (5) with respect to all of the calculation points p, that is, until “N⁽ⁱ⁺¹⁾=0” is satisfied. This makes it possible to obtain maximum conducted powers

$${P}_{n}^{′}$$

respectively allowed to all of the communication apparatuses.

In the above-described example illustrated in FIG. 8, pa represents a calculation point in the PPA_A of the lessor A, and I_{CBSD_B,,p_A} and I_{CBSD_C,,p_A} respectively represent interference powers due to respective grants for the CBSD_B of the lessee B and the CBSD_C of the lessee C. Likewise, p_{B} and p_{C} respectively represent calculation points in the PPA_B of the lessee B and the PPA_C of the lessee C, and I_{CBSDA,,p_B} and I_{CBSD_A,,p_C} each represent interference power due to a grant for the CBSD_A of the lessor A.

The interference power I_{CBSD_B,,p_A} and the interference power ICBSD_C,p_A are taken into consideration when cumulative interference power of cumulative interference with each calculation point in the PPA_A is calculated, I_{CBSD_A,,p_B} is taken into consideration when cumulative interference power of cumulative interference with a calculation point in the PPA_B is calculated, and I_{CBSD_A,,p_C} is taken into consideration when cumulative interference power of cumulative interference with a calculation point in PPA_C is calculated. In other words, the grant for one of the CBSD_A and each of the CBSD_B and the CBSD_C is a calculation target for calculation performed in the IAP with respect to the PPA for another of the CBSD_A and each of the CBSD_B and the CBSD_C.

As a result, the CBSD_A is protected from other CBSDs (that include the CBSD_B and the CBSD_C and that can further include a CBSD having a PAL grant in another county neighboring on the county of the CBSD_A), and from a CBSD having a GAA grant. The CBSD_B is protected from other CBSDs (that include the CBSD_A and the CBSD_C and that can further include a CBSD having a PAL grant in another county neighboring on the county of the CBSD_A), and from a CBSD having a GAA grant. The CBSD_C is protected from other CBSDs (that include the CBSD_A and the CBSD_B and that can further include a CBSD having a PAL grant in another county neighboring on the county of the CBSD_A), and from a CBSD having a GAA grant.

When the above-described IAP disclosed in R2-SGN-16 in Non-Patent Literature 1 is adopted, there may be a great reduction in an allowed transmission power for the grant for the CBSD_A of the lessor A in order to protect the PPA_B and the PPA_C, depending on a positional relationship between each of the PPA_B and the PPA_C, and the CBSD_A. This may be undesirable to the operator A by which the PAL has been leased.

In the present embodiment, a priority relationship is set between a PAL lessor and a PAL lessee, that is, between a CBSD of a lessor and a CBSD of a lessee. For example, the level of priority of the CBSD of the lessor is set higher than the level of priority of the CBSD of the lessee. When the CBSD of the lessor is a first communication apparatus and the CBSD of the lessee is a second communication apparatus, the level of priority of the first communication apparatus is set higher than the level of priority of the second communication apparatus.

On the basis of such a level of priority, the processor 32 of the SAS 130 determines a PAL grant of a calculation target for calculation performed in the IAP with respect to each PPA. When the IAP with respect to each PPA is performed, a PAL grant for a CBSD having a higher priority than a CBSD associated with the PPA is set to be a non-calculation-target PAL grant, and a PAL grant for a CBSD other than the non-calculation-target PAL grant is set to be a calculation target for calculation performed in the IAP. The setting a PAL grant for a high-priority CBSD as a non-calculation-target PAL grant means that a communication apparatus associated with the determined PAL grant is not included in calculation-target communication apparatuses n in the flowchart in FIG. 9. In other words, the setting a PAL grant for a high-priority CBSD as a non-calculation-target PAL grant means that an amount of a reduction in transmission power of the CBSD is set to zero. As described above, it is determined, on the basis of the priority relationship, that an amount of a reduction in transmission power of a high-priority CBSD is set to zero. This makes it possible to avoid reduction in an allowed transmission power for a PAL grant for a non-calculation-target CBSD. A reduction in an allowed transmission power of a corresponding communication apparatus is prevented.

Here, the level of priority can be set by, for example, various methods as indicated below.
The processor 32 of the SAS 130 sets the level of priority in accordance with, for example, a contract between a lessor and a lessee.
For example, the processor 32 of the SAS 130 acquires, from an external database, information regarding the level of priority set for a PAL lessor and a PAL lessee, where the external database is managed or operated by, for example, a national or regional radio administrative agency (such as the ULS operated by the FCC).
The processor 32 of the SAS 130 acquires the level of priority of each CBSD (the level of priority of an operator that operates each CBSD) in procedures performed together with at least one of the CBSD_A, the CBSD_B, or the CBSD_C.
A default of the level of priority is set in advance for a PAL lessor and a PAL lessee, and the default level of priority is used when it is difficult to acquire the level of priority using any of the methods described above. The default level of priority may be stored in a storage that can be accessed by the processor 32 of the SAS 130. Alternatively, the processor 32 of the SAS 130 may omit the processing of determining the level of priority of a calculation-target PAL grant when it is difficult to acquire the level of priority using any of the methods described above.

A specific example of determining, on the basis of the level of priority, a PAL grant that is a calculation target for calculation performed in the IAP with respect to each PPA, is described below.

It is assumed that, for example, a high level of priority is set for the lessor A and a low level of priority is set for the lessee B, C. In this case, the processor 32 of the SAS 130 sets a grant for each of the CBSD_B and the CBSD_C of the low-priority lessees B and C as a target for performing the IAP with respect to the PPA_A for the high-priority CBSD_A. The processor 32 of the SAS 130 determines permission for a current grant for each of the CBSD_B and the CBSD_C or a reduction amount necessary for the permission, on the basis of an allowed interference power of the CBSD_A and a corresponding one of the interference power I_{CBSD_B,,p_A} of interference from the CBSD_B and the interference power I_{CBSD_C,,p_A} of interference from the CBSD_C. The processor 32 of the SAS 130 determines an allowed transmission power of each of the CBSD_B and the CBSD_C on the basis of the determined reduction amount. Note that this processing may be performed when, for example, the spectrum grant procedure is performed. Instead of the permission for the current grant, the processor 32 of the SAS 130 may determine permission for newly issuing a grant in response to a request being made by each of the CBSD_B and the CBSD_C upon performing the spectrum grant procedure, or may determine a reduction amount necessary for the permission.

On the other hand, the processor 32 of the SAS 130 excludes the grant for the CBSD_A of the high-priority lessor A from a target for performing the IAP with respect to each of the PPA_B for the CBSD_B of the low-priority lessee B and the PPA_C for the CBSD_C of the low-priority lessee C. As a result, an amount of a reduction in transmission power is set to zero, the reduction amount being necessary for permission for the grant for the CBSD_A. This makes it possible to allow a higher transmission power for the grant for the CBSD_A. When the level of priority of the lessor A is lower than or equal to the level of priority of the lessee B, C, the processor 32 of the SAS 130 determines permission for a current grant for the CBSD_A or a reduction amount necessary for the permission, on the basis of each of an allowed interference power of the CBSD_B and an allowed interference power of the CBSD_C, and on the basis of a corresponding one of the interference power I_{CBSD_A,,p_B} of interference from the CBSD_A and the interference power I_{CBSD_A,,p_C} of interference from the CBSD_A. When the lessor A has a higher priority than the lessee, a reduction in transmission power is prevented or an amount of the reduction is made smaller, compared to when the level of priority of the lessor A is lower than or equal to the level of priority of the lessee, as described above.

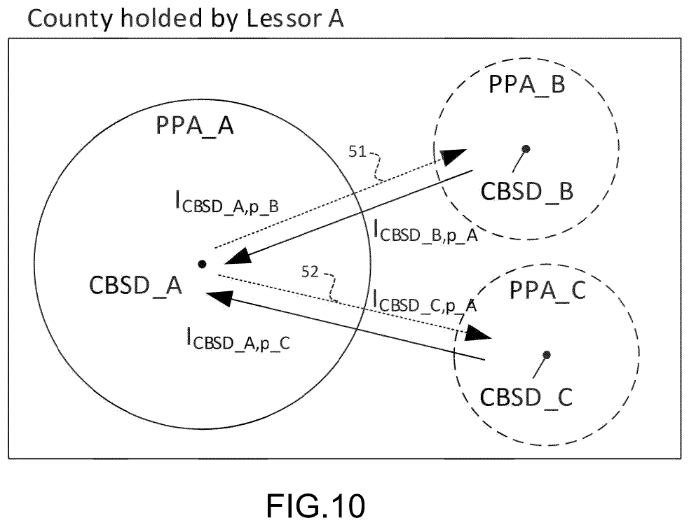

FIG. 10 illustrates an example of excluding the grant for the CBSD_A of the lessor A from a target for performing the IAP with respect to each of the PPA_B and the PPA_C. There is no need to consider the interference power I_{CBSD_A,,p_B}, I_{CBSD_A,, p_C} upon determining permission for a current grant for the CBSD_A or a reduction amount necessary for the permission (refer to dotted lines 51 and 52 with arrows). This results in there being no need to take into consideration interference with each of the PPA_B and the PPA_C from the CBSD_A, and thus in an allowed transmission power for the grant for the CBSD_A of the lessor A not being limited by the PPA_B or the PPA_C. As a result, a high allowed transmission power can be allowed to the grant for the CBSD_A.

Interference with a PPA for another CBSD for which no priority relationship with the grant for the CBSD_A is set, that is, for example, a PPA for another CBSD operated by another PAL holder in another county, is taken into consideration, as in the case of the usual IAP. Thus, the allowed transmission power for the grant for the CBSD_A is limited according to the interference with the PPA for the other CBSD.

According to the IAP according to the present embodiment, interference from the high-priority CBSD_A with each of the PPA_B and the PPA_C respectively associated with the low-priority CBSD_B and the low-priority CBSD_C is not taken into consideration, and interference margin (an amount of allowed interference power) for the PPA_B and interference margin (an amount of allowed interference power) for the PPA_C that were supposed to be assigned to the CBSD_A are excessive. If the processor 32 of the SAS 130 assigns the excessive interference margin to a surrounding CBSD (a third communication apparatus), this results in other PAL holders not being put at a disadvantage due to such determination of a level of priority. The third communication apparatus may be a CBSD of another PAL holder that uses a surrounding county. Alternatively, the third communication apparatus may be a CBSD of which a level of priority is lower than or equal to the level of priority of the CBSD_B and the CBSD_C.

On the other hand, the PPAs of the lessees B and C for which a low level of priority is set are greatly interfered with due to the grant for the CBSD_A. However, the following are calculation targets for calculation performed in the IAP:
a CBSD of the other lessee having the equal level of priority,
a PAL holder, in another county, that is other than the lessor having leased the PAL to the lessee, and
a GAA having a lower priority than a PAL.
   Thus, the PPAs of the lessees B and C are protected from being interfered with by these CBSDs with certainty.

Note that, in the present embodiment, the level of priority of the lessor and the level of priority of the lessee may be reversed.

Further, the level of priority may be set for a relationship other than the relationship between a lessor and a lessee. For example, CBSDs of a plurality of lessees each having leased a license from one lessor may be respectively given different levels of priorities. In this case, interference with a PPA of a low-priority lessee due to a grant for another lessee having a high priority may be excluded from a calculation target for calculation performed in the IAP with respect to the PPA. This makes it possible to reduce a reduction in an allowed transmission power for the grant for the high-priority lessee.

Furthermore, when, for example, a PAL holder installs a plurality of CBSDs in one county, the level of priority may be set for the CBSDs of the one holder.

<3.2 When there is Plurality of License Areas>

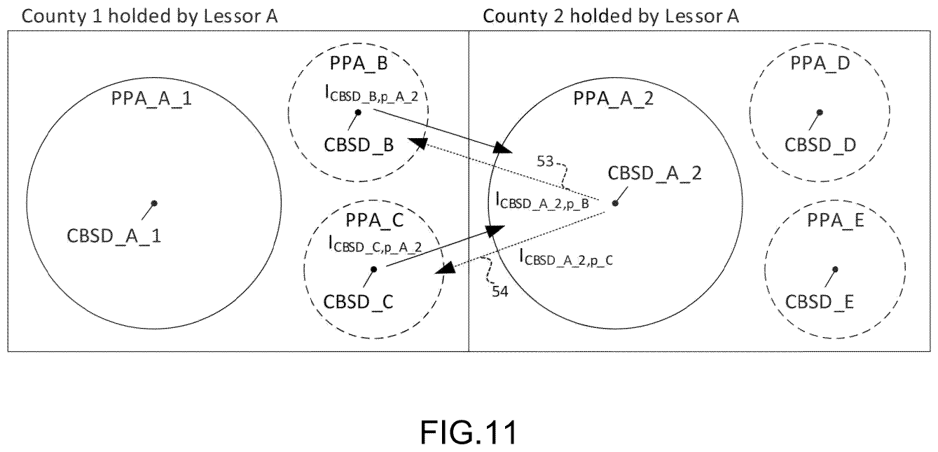

One operator may hold PALs for one channel in different counties and lease the PALs in the respective counties. In this case, the level of priority may also be set for a lessor and a lessee in the different counties, and the processor 32 of the SAS 130 may determine a PAL grant that is a calculation target for calculation performed in the IAP with respect to each PPA, as in the case of <3.1>. A specific example is described below with reference to FIG. 11.

FIG. 11 illustrates an example in which the lessor A holds PALs for one channel in counties 1 and 2 and leases the PALs in the respective counties. The operator A leases the PAL to the operators B and C in the county 1, and leases the PAL to operators D and E in the county 2.

A CBSD_A_1 of the operator A, the CBSD_B of the operator B, and the CBSD_C of the operator C are installed in the county 1, and a PPA_A_1, the PPA_B, and the PPA_C for the respective CBSDs are calculated. Likewise, a CBSD_A_2 of the operator A, a CBSD D of the operator D, and a CBSD E of the operator E are installed in the county 2, and a PPA_A_2, a PPA D, and a PPA E for the respective CBSDs are calculated. An SAS that manages the CBSD_A_2, the CBSD D, and the CBSD E may be the SAS 130 or another SAS.

The level of priority is set for each of the CBSD_B and the CBSD_C in the county 1 and the CBSD_A_2 in the county 2. It is assumed that the CBSD_A_2 of the lessor A that is installed in the county 2 has a high priority, and that the CBSD_B and CBSD_C installed in the county 1 have a low priority. In this case, a grant for the high-priority CBSD_A_2 of the lessor A is excluded from a target for performing the IAP with respect to each of the PPAs for the low-priority CBSD_B and CBSD_C. There is no need to consider interference power I_{CBSD_A_2,p_B} of interference with the PPA_B in the county 1 and interference power I_{CBSD_A_2, p_C} of interference with the PPA_C in the county 1 upon determining permission for a current grant for the CBSD_A_2 in the county 2 or a reduction amount necessary for the permission (refer to dotted lines 53 and 54 with arrows). This results in an allowed transmission power for the grant for the CBSD_A_2 in the county 2 not being limited by the PPA_B or the PPA_C in the county 1. As a result, a higher allowed transmission power can be allowed to the grant for the CBSD_A_2.

In the example illustrated in FIG. 11, two different counties are neighboring counties. However, the different counties may be non-neighboring counties.

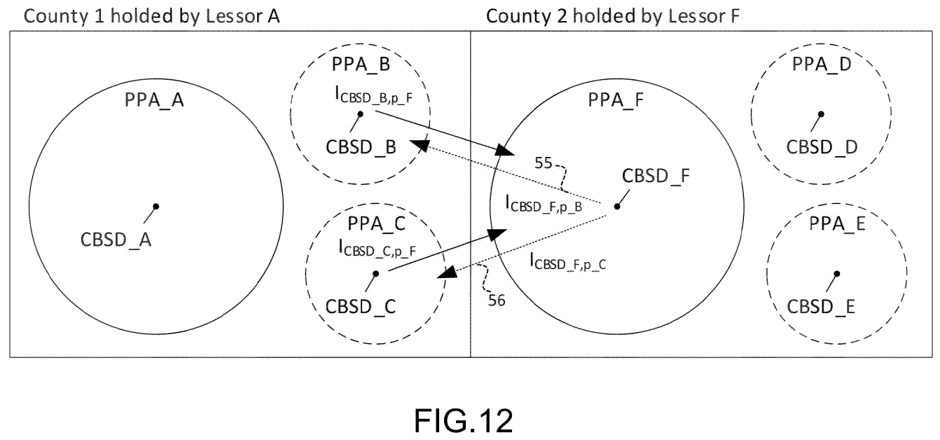

In the example illustrated in FIG. 11, one operator holds PALs for one channel in two different counties. However, different operators may hold PALS for one channel in respective counties. In this case, processing similar to the processing in the example illustrated in FIG. 11 may also be performed when the respective operators serve as lessors and independently lease their PALs in the counties in which they hold their PALs. Likewise, for example, the level of priority can also be set for a lessor belonging to a county in which a certain operator has a PAL, and a lessee belonging to a county in which another operator has a PAL. A specific example of this is described with reference to FIG. 12.

FIG. 12 illustrates an example in which the lessor A holds a PAL for a channel in the county 1, a lessor F holds a PAL for the channel in the county 2, the lessor A leases its PAL to the lessees B and C, and the lessor F leases its PAL to the lessees D and E.

The level of priority is set for a CBSD_F that is installed in the county 2 and each of the CBSD_B and CBSD_C installed in the county 1. Specifically, the level of priority of the CBSD_F of the lessor F that is installed in the county 2 is set higher than the level of priority of each of the CBSD_B and CBSD_C installed in the county 1. In this case, a grant for the high-priority CBSD_F of the lessor F may be excluded from a target for performing the IAP with respect to each of the PPAs for the low-priority CBSD_B and CBSD_C. In other words, there is no need to consider interference power I_{CBSD_F,,p_B} of interference with the PPA_B in the county 1 from the CBSD_F and interference power I_{CBSD_F,p_C} of interference with the PPA_C in the county 1 from the CBSD_F upon determining permission for a current grant for the CBSD_F in the county 2 or a reduction amount necessary for the permission (refer to dotted lines 55 and 56 with arrows). This results in an allowed transmission power for the grant for the CBSD_F in the county 2 not being limited by the PPA_B or the PPA_C in the county 1. As a result, a higher allowed transmission power can be allowed to the grant for the CBSD_F.

### MODIFICATIONS

The processor 32 of the SAS 130 may group a plurality of CBSDs on the basis of certain criteria, may set the level of priority for CBSDs in each group, and may determine, for each group, a PAL grant that is a calculation target for calculation performed in the IAP with respect to a PPA for each CBSD. For example, a CBSD of a lessor and a CBSD of a lessee having leased a PAL from the lessor that are situated in one county may be grouped, and a PAL grant that is the calculation target may be determined for each group.

Here, the processor 32 of the SAS 130 may first obtain interference margin assigned to each group, and may distribute the interference margin for each group to the respective CBSDs in the group on the basis of the level of priority to give permission for a grant for the CBSD or to obtain an amount of a reduction in transmission power, the reduction amount being necessary for the permission. The interference margin assigned to each group may be interference margin of interference with an optional calculation point. The optional calculation point may be a calculation point in a protection area related to Incumbent, may be a calculation point in a PPA for each CBSD belonging to another group, or may be a calculation point determined using another approach.

### <3.3 Other Methods for Distributing Interference Margin>

The example in which interference margin that was supposed to be assigned to the grant for the CBSD_A excluded from the calculation target can be assigned to, for example, a CBSD (the third communication apparatus) of another PAL holder in another county, has been described in <3.1>. However, in this case, interference with the PPA_B and interference with the PPA_C may be increased since transmission power of the CBSD_A is excluded from the calculation target. Thus, such an issue may be solved or alleviated using any of the methods of Examples 1 to 5 indicated below.

[Example 1] Thus, a value that corresponds to a grant for the CBSD_A excluded from the calculation target may be subtracted from interference margin (an allowed interference power) with respect to each of the PPA_B and the PPA_C, and the IAP may be performed on the basis of interference margin obtained by the subtraction to distribute the interference margin to, for example, a CBSD (the third communication apparatus) of another PAL holder in another county. The interference margin is not limited to being distributed to a CBSD of another PAL holder in another county, and may be distributed to a CBSD of which the level of priority is lower than the level of priority of the CBSD_B and the CBSD_C, or to a CBSD (that can be the CBSD_C or the CBSD_B) of which the level of priority is equal to the level of priority of the CBSD_B and the CBSD_C. This makes it possible to reduce interference with each of the PPA_B and the PPA_C from, for example, a CBSD of another PAL holder.

The value subtracted from interference margin may be determined on the basis of, for example, a distance between a CBSD (the CBSD_A) for a grant excluded from the calculation target and each of the PPA_B and the PPA_C, or on the basis of a priority relationship between CBSD_A to CBSD_C. The value subtracted from the interference margin may be a specified value.

Further, when a plurality of grants is excluded from the calculation target, a value to be subtracted may be determined for each grant, and a value obtained by adding the values determined for the respective grants may be subtracted from interference margin. Interference margin obtained by the subtraction may be used as a reference when interference margin is distributed in the IAP.

Furthermore, the value subtracted from [0257] interference margin may be calculated using a method indicated below. In other words, first, the IAP is performed with respect to each of Incumbent (a protection-target system or the primary system) and a PPA of another PAL holder in another county to obtain an amount of a reduction in transmission power of the CBSD_A, where Incumbent and the PPA of the other PAL holder in the other county are protection targets. This reduction amount is subtracted from transmission power allowed by the grant for the CBSD_A, and then an interference budget of interference with each of the PPA_B and the PPA_C (an estimated amount of interference with each of the PPA_B and the PPA_C from the CBSD_A) is calculated.

When the IAP is performed with respect to each of the PPA_B and the PPA_C, each of the interference budgets respectively calculated for the PPA_B and the PPA_C is used as a distribution amount of distribution of interference margin to the grant for the CBSD_A with respect to a corresponding one of the PPA_B and the PPA_C. The distribution amount of distribution of interference margin is set to be a value to be subtracted from interference margin with respect to each of the PPA_B and the PPA_C. The distribution amount of distribution of interference margin to the CBSD_A is subtracted from interference margin (an allowed interference amount) with respect to each of the PPA_B and the PPA_C to calculate the remaining interference margin with respect to a corresponding one of the PPA_B and the PPA_C. The remaining interference margin obtained by the calculation may be distributed to the third communication apparatus described above, or may be distributed to a GAA-grant CBSD that is a fourth communication apparatus other than the third communication apparatus. The GAA-grant CBSD is a communication apparatus allowed to transmit radio waves on the basis of the right to secondarily use a spectrum with a level of priority that is lower than the level of priority of a PAL-grant CBSD.

Note that, when there is a need to also consider a PAL grant in another county (a PAL grant of the same PAL holder or another PAL holder) at the same time, first, the IAP with respect to each of Incumbent and a PPA of the other PAL holder is performed for the PAL grant in the other county to obtain an interference budget of interference with each of the PPA_B and the PPA_C, as in the case of the CBSD_A. Each of the interference budgets may be used as a distribution amount of distribution of interference margin to the above-described PAL grant in the other county with respect to a corresponding one of the PPA_B and the PPA_C.

[Example 2] Further, when the IAP is performed with respect to each of the low-priority PPA_B and PPA_C, the IAP is also performed with respect to a grant for the high-priority CBSD_A that is considered the calculation target, and then an amount of a reduction in transmission power of the CBSD_A is obtained. A value obtained by subtracting any amount from the obtained amount of the reduction in the transmission power of the CBSD_A, or a value obtained by dividing, by any amount, the obtained amount of the reduction in the transmission power of the CBSD_A may be used as a new amount of a reduction in transmission power with respect to the grant for the CBSD_A. Here, the subtracted amount or the amount by which division is performed may be determined on the basis of a distance between a PPA (the PPA_B, the PPA_C) of a lessee and a CBSD (the CBSD_A) of a lessor. For example, setting may be performed such that the reduction amount is smaller if the distance to the PPA of the lessee is larger and such that the reduction amount is larger if the distance is smaller. The subtracted amount or the amount by which division is performed may be a constant amount.

Note that, when a PAL grant in another county (a PAL grant of the same PAL holder or another PAL holder) is also considered at the same time, an amount of a reduction in transmission power may be obtained by performing the IAP, and a value obtained by subtracting any amount from the reduction amount, or a value obtained by dividing the reduction amount by any amount may be used as a new reduction amount with respect to the PAL grant in other county, as in the case of the lessor.

[Example 3] When the IAP is performed with respect to each of the low-priority PPA_B and PPA_C, the IAP may be performed with respect to a high-priority grant using a preset fixed value as a reduction amount necessary for permission for the grant for the CBSD_A or as an allowed transmission power after the reduction to reduce interference with a corresponding one of the low-priority PPA_B and PPA_C to some extent. Here, the fixed reduction amount or the fixed transmission power may be determined on the basis of a distance between each of the low-priority PPA_B and PPA_C of lessees and the CBSD_A of a lessor (or a distance between each of the CBSD_B and the CBSD_C and the CBSD_A). For example, setting may be performed such that an amount of a reduction in transmission power for a grant for the CBSD of the lessor is smaller if the distance to the PPA of the lessee is larger and such that the reduction amount is larger if the distance is smaller. Note that the fixed value used here does not necessarily have to be used as a reduction amount that is actually reported to the CBSD_A or as an allowed transmission power after the reduction.

Note that, when a PAL grant in another county (a PAL grant of the same PAL holder or another PAL holder) is also considered at the same time, a preset fixed value may be used as an amount of a reduction in transmission power, the reduction amount being necessary for permission for the grant in the other county, or may be used as an allowed transmission power after the reduction, as in the case of the lessor.

[Example 4] When at least three levels of priorities are set for CBSDs of lessors or for CBSDs of lessees, the above-described subtraction amount, division amount, reduction amount, or transmission power may be determined according to the level of priority. For example, setting may be performed such that the reduction amount is smaller if the level of priority is higher and such that the reduction amount is larger if the level of priority is lower.

Note that, instead of setting the fixed value described above according to the level of priority, the fixed value may be set in advance according to a priority relationship between CBSDs. In this case, there is no need to perform processing of setting a fixed value according to the level of priority.

[Example 5] In order to give a lessor priority over a lessee, the proportion for distributing interference margin may be changed such that a larger portion of the interference margin is distributed to a grant for the lessor than a grant for the lessee when the IAP is performed with respect to an optional protection target. This may result in reducing a reduction in an allowed transmission power of the lessor. For example, Non-Patent Literature 1 discloses that interference margin obtained by performing the IAP to equally divide, by the number of calculation-target grants, a total amount of interference margin of interference at a calculation point p in a PPA, is used as interference margin assigned to each CBSD. A larger portion of interference margin may be distributed to a grant for the lessor than a grant for the lessee by setting a proportion (a first proportion) other than the equal division proportion to be the division proportion. A specific calculation method to distribute interference margin is described below.

When a total amount of interference margin is represented by Q_{p (dBm)}, and a total number of calculation-target grants is represented by Nₚ, interference margin assigned to each grant when equal division is performed is represented by

$${10}^{\frac{{Q}_{p ( dBm )}}{10}} / {N}_{p} .$$

Here, when the number of grants for a certain lessor A is represented by _{p,Lessor}_{_{A}}, and a total number of grants for lessees that lease PALs from the lessor A is represented by N_{p,Lessee}_{_{A}}, the sum total Q_{p,Lessor}_{_{A}}_{(dBm)} of interference margin assigned to the grant for the lessor A and the grant for the lessee can be represented by Formula (6) indicated below.

$${Q}_{p , {Lessor}_{A} ( dBm )} = 10 \cdot {log}_{10} \{ {10}^{\frac{{Q}_{p ( dBm )}}{10}} / {N}_{p} \cdot ( {N}_{p , {Lessor}_{A}} + {N}_{p , {Lessee}_{A}} ) \} \qquad ( 6 )$$

When an assignment proportion in which a larger portion of interference margin is assigned to a lessor is calculated for a grant for the lessor A and a grant for the lessee to distribute Q_{p,Lessor}_{_{A}}_{(dBm)} to the grant for the lessor A and the grant for the lessee, the interference margin Q_{p,Lessor}_{_{A}}_{(dBm)} can be distributed using a method indicated below. For example, proportion parts used to assign portions of the interference margin Q_{p,Lessor}_{_{A}}_{(dBm)} to respective grants for a lesser and a lessee are represented by λ_{p,Lessor}_{_{A}} and λ_{p,Lessee}_{_{A}}, which satisfy conditions indicated using Formulas (7) and (8) indicated below.

$$\begin{matrix}[ Math . 8 ] & \\ {λ}_{p , {Lessor}_{A}} > \frac{1}{{N}_{p , {Lessor}_{A}} + {N}_{p , {Lessee}_{A}}} > {λ}_{p , {Lessee}_{A}} & ( 7 )\end{matrix}$$

$$\begin{matrix}[ Math . 9 ] & \\ {\sum }_{{N}_{p , {Lessor}_{A}}} {λ}_{p , {Lessor}_{A}} + {\sum }_{{N}_{p , {Lessee}_{A}}} {λ}_{p , {Lessee}_{A}} = 1 & ( 8 )\end{matrix}$$

Here, portions of interference margin that are actually distributed to the respective grants for a lesser and a lessee are

$${10}^{\frac{{Q}_{p , {Lessor}_{A} ( dBm )}}{10}} \cdot {λ}_{p , {Lessor}_{A}} and {10}^{\frac{{Q}_{p , {Lessor}_{A} ( dBm )}}{10}} - {λ}_{p , {Lessee}_{A}} ,$$

respectively. With respect to determination of λ_{p,Lessor}_{_{A}} and λ_{p,Lessee}_{_{A}}, for example, a fixed value that is larger than 1/(N_{p,Lessor}_{_{A}}) set in advance may be set to be λ_{p,Lessor}_{_{A}}, and a value obtained by subtracting the fixed value from one may be divided between the lessees, as represented by Formula (9) indicated below.

$$\begin{matrix}[ Math . 10 ] & \\ {λ}_{p , {Lessee}_{A}} = ( 1 - {\sum }_{{N}_{p , {Lessor}_{A}}} {λ}_{p , {Lessor}_{A}} ) / {N}_{p , {Lessee}_{A}} & ( 9 )\end{matrix}$$

Conversely, a fixed value that is smaller than 1/(N_{p,Lessor}_{_{A}}+N_{p,Lessee}_{_{A}}) may be given as λ_{p,Lessee}_{_{A}} in advance, a value obtained by subtracting the fixed value from one may be divided between the lessors, and a value obtained by the division may be used as λ_{p,Lessor}_{_{A}}, as in the case of Formula (9).

Alternatively, with respect to the total amount Q_{p (dBm)} of interference margin, which also includes an interference amount distributed to another PAL holder, portions of the interference margin may be assigned to grants for the lessor A and the other PAL holder with the proportion part λₚ, and a portion of the interference margin may be assigned to a grant for the lessee corresponding to the lessor A with the proportion part λ_{p,Lessee}. In this case, a larger portion of the interference margin may be assigned to the grant for each of the lessor and the other PAL holder than the grant for the lessee by λₚ and λ_{p,Lessee} being set to satisfy conditions indicated using Formulas (10) and (11) indicated below.

$$\begin{matrix}[ Math . 11 ] & \\ {λ}_{p} > \frac{1}{{N}_{p}} > {λ}_{p , Lessee} & ( 10 )\end{matrix}$$

$$\begin{matrix}[ Math . 12 ] & \\ {\sum }_{{N}_{p} - {N}_{p , {Lessee}_{A}}} {λ}_{p} + {\sum }_{{N}_{p , {Lessee}_{A}}} {λ}_{p , {Lessee}_{A}} = 1 & ( 11 )\end{matrix}$$

Further, a fixed value may be set to be one of λₚ and λ_{p,Lessee} in advance, and another of λₚ and λ_{p,Lessee} may be obtained by dividing, by a corresponding number of grants, a value obtained by subtracting the fixed value from one, as in the case of Formula (9).

The example in which a larger portion of interference margin is assigned to a lessor than a lessee, has been described. However, conversely, a larger portion of interference margin may be assigned to the lessee than the lessor.

Further, apparent interference power used to perform the IAP may be reduced by adding a certain amount of apparent propagation loss when each of interference power of interference with a CBSD of a lessee from a CBSD of the lessor and interference power of interference with the CBSD of the lessee from a CBSD of another PAL holder is calculated in the IAP. This enables transmission with power higher than power used upon performing the usual IAP to be allowed to each of a grant for the CBSD of the lessor and a grant for the CBSD of the other PAL holder. In this case, the grant for the CBSD of the lessee is more greatly interfered with, compared to when calculation is performed in the usual IAP. However, an actual allowed transmission power for each of the grant for the CBSD of the other PAL holder and the grant for the CBSD of the lessor can be increased.

Note that a distribution amount of distribution of interference margin can also be reduced by treating a grant of another PAL holder as a grant of a lessee, or by reducing an added apparent propagation loss with respect to the grant of the other PAL holder, compared to a lessor. However, in this case, an allowed transmission power for the grant of the other PAL holder is more greatly reduced, compared to the grant of the lessor. This is not desirable in terms of fairness.

Further, when at least three levels of priorities are set for CBSDs of lessors or for CBSDs of lessees, the above-described the proportion for assigning interference margin or added amount of apparent propagation loss may be determined according to the level of priority. For example, the assignment proportion or added amount of apparent propagation loss may be greater if the level of priority is higher.

Note that the proportion described above may be set first according to a priority relationship between CBSDs instead of setting the proportion according to the level of priority. This results in there being no need for processing of setting the proportion according to the level of priority.

Further, only when a low-priority CBSD is situated in an environment in which an additional loss can be considered for a loss in propagation from a high-priority CBSD, the IAP may be performed as usual with respect to a PPA for the low-priority CBSD in consideration of interference from the high-priority CBSD. This results in determining, as usual, permission for a grant for the high-priority CBSD and a reduction amount necessary for the permission for the grant. The environment in which an additional loss can be considered for a propagation loss may be, for example, an environment in which it is clearly stated that a CBSD of a lessee is installed indoors and an additional loss such as a building entry loss can be considered for a loss in propagation from a high-priority CBSD.

### <3.4 Information Exchange Between SASs>

When a PPA is protected on the basis of the level of priority described in <3.1> to <3.3>, the SAS 130 may also exchange priority information upon exchanging information with another SAS, since all of the SASs acquire similar results.

However, there is no need to exchange priority information when the other SAS does not perform such a PPA protection based on the level of priority.

On the other hand, if only the SAS 130 protects a PPA on the basis of the level of priority when the other SAS does not perform such a PPA protection based on the level of priority, there may be a difference between the SASs in calculation result.

Thus, the processor 32 of the SAS 130 may perform processing based on the level of priority only when all of the SASs managing CBSDs situated in a neighborhood of a protection target (here, a PPA of a lessee) each include a function according to the present disclosure or only when only a CBSD managed by the SAS 130 itself is situated in the neighborhood, as disclosed in REL2-R3-SGN-06 and REL2-R3-SGN-07 in Non-Patent Literature 10.

According to the present embodiment, the level of priority is set for CBSDs respectively operated by a lessor and a lessee of a PAL, and an SAS performs an IAP in consideration of the set level of priority, as described above. This makes it possible to avoid reducing an allowed transmission power of the CBSD of the lessor or the lessee while sufficiently securing a leasable range in which the PAL can be leased.

Note that the embodiments described above are examples used to embody the present disclosure, and the present disclosure may be embodied in a variety of other embodiments. For example, various modifications, replacements, omissions, or combinations thereof may be applied without departing from the scope of the present disclosure. Embodiments obtained by applying, for example, such modifications, replacements, or omissions are also included in the scope of the present disclosure, as well as the scope of embodiments of the present disclosure and their equivalents.

Further, the effects described herein are merely illustrative, and other effects may be provided.

Note that the present disclosure may take the following configurations.
(1) A communication control apparatus, including
   a processor
      that acquires information indicating a priority relationship in interference protection between a first communication apparatus and a second communication apparatus that each transmit radio waves,
      that determines an amount of a reduction in a transmission power of the first communication apparatus on the basis of the information indicating the priority relationship and an allowed interference power of the second communication apparatus, and
      that determines an allowed transmission power of the first communication apparatus on the basis of the reduction amount.
(2) The communication control apparatus according to (1), in which
   when the first communication apparatus has a level of priority higher than a level of priority of the second communication apparatus, the processor reduces the reduction amount, compared to when the first communication apparatus has a level of priority lower than or equal to the level of priority of the second communication apparatus.
(3) The communication control apparatus according to (2), in which
   when the first communication apparatus has a level of priority higher than the level of priority of the second communication apparatus, the processor sets the reduction amount to zero.
(4) The communication control apparatus according to (3), in which
   the processor
      distributes the allowed interference power of the second communication apparatus to at least one third communication apparatus,
      determines an allowed transmission power of the third communication apparatus on the basis of the allowed interference power distributed to the third communication apparatus, and
      does not distribute the allowed interference power of the second communication apparatus to the first communication apparatus, and
   the third communication apparatus is a communication apparatus for which the priority relationship with the first communication apparatus and the second communication apparatus is not set, or
   the third communication apparatus is a communication apparatus for which the priority relationship with the first communication apparatus and the second communication apparatus is set, and that has a level of priority lower than or equal to the level of priority of the second communication apparatus.
(5) The communication control apparatus according to any one of (2) to (4), in which
   the processor
      subtracts, from the allowed interference power of the second communication apparatus, an interference budget that indicates an amount of interference with the second communication apparatus that is performed when the first communication apparatus transmits the radio waves with the transmission power,
      distributes an allowed interference power obtained by the subtraction to a third communication apparatus, and
      determines an allowed transmission power of the third communication apparatus on the basis of the allowed interference power distributed to the third communication apparatus, and
   the third communication apparatus is a communication apparatus for which the priority relationship with the first communication apparatus and the second communication apparatus is not set, or
   the third communication apparatus is a communication apparatus for which the priority relationship with the first communication apparatus and the second communication apparatus is set, and that has a level of priority lower than or equal to the level of priority of the second communication apparatus.
(6) The communication control apparatus according to (5), in which
   the processor determines the transmission power of the first communication apparatus on the basis of an allowed interference power of an optional protection target, and
   the interference budget indicates an amount of interference with the second communication apparatus that is performed when the first communication apparatus transmits the radio waves with the determined transmission power.
(7) The communication control apparatus according to (6), in which
   the protection target includes at least one of a primary system or the third communication apparatus, the primary system preferentially using the radio waves over the first communication apparatus and the second communication apparatus.
(8) The communication control apparatus according to any one of (2) to (7), in which
   each of the first communication apparatus and the second communication apparatus transmits the radio waves on the basis of a certain right to preferentially secondarily use a spectrum,
   the processor
      subtracts, from the allowed interference power of the second communication apparatus, an interference budget that indicates an amount of interference with the second communication apparatus that is performed when the first communication apparatus transmits the radio waves with the transmission power, and
      distributes an allowed interference power obtained by the subtraction to a fourth communication apparatus, and
   the fourth communication apparatus is a communication apparatus that transmits the radio waves on the basis of another right to secondarily use the spectrum, the other right being given lesser priority than the certain right.
(9) The communication control apparatus according to any one of (2) to (8), in which
   the processor
      distributes the allowed interference power of the second communication apparatus at least to the first communication apparatus,
      determines the reduction amount according to the allowed interference power distributed to the first communication apparatus, and according to an interference budget that indicates an amount of interference with the second communication apparatus that is performed when the first communication apparatus transmits the radio waves with the transmission power,
      adjusts the reduction amount by reducing the reduction amount by an optional value, and
      determines the allowed transmission power of the first communication apparatus on the basis of a reduction amount obtained by the adjustment.
(10) The communication control apparatus according to (9), in which
   the processor determines the optional value according to a distance between the first communication apparatus and the second communication apparatus.
(11) The communication control apparatus according to any one of (2) to (10), in which
   the processor
      determines the allowed transmission power of the first communication apparatus using a preset fixed value as the amount of the reduction in the transmission power of the first communication apparatus, or
      determines the allowed transmission power of the first communication apparatus using the preset fixed value as a transmission power obtained by reducing the transmission power of the first communication apparatus by the low power amount.
(12) The communication control apparatus according to any one of (1) to (11), in which
   the processor
      determines the transmission power of the first communication apparatus and the transmission power of the second communication apparatus by distributing an allowed interference power of an optional protection target to the first communication apparatus and the second communication apparatus in a first proportion, and
      determines the first proportion according to the priority relationship between the first communication apparatus and the second communication apparatus.
(13) The communication control apparatus according to (12), in which
   the priority relationship indicates that one of the first communication apparatus and the second communication apparatus has priority over another of the first communication apparatus and the second communication apparatus, and
   the processor causes a larger portion of the allowed interference power to be distributed to the one of the first communication apparatus and the second communication apparatus than the other of the first communication apparatus and the second communication apparatus.
(14) The communication control apparatus according to any one of (2) to (13), in which
   the processor determines the reduction amount for the one of the first communication apparatus and the second communication apparatus by causing a propagation loss to apparently become larger, the propagation loss being a loss in propagation from the one of the first communication apparatus and the second communication apparatus to the other of the first communication apparatus and the second communication apparatus.
(15) The communication control apparatus according to (13) or (14), in which
   the first communication apparatus is a communication apparatus that is operated by a first operator that has a right to preferentially secondarily use a spectrum, and
   the second communication apparatus is a communication apparatus that is operated by a second operator that has leased the right from the first operator.
(16) The communication control apparatus according to any one of (2) to (15), in which
   the processor determines whether the first communication apparatus is situated in an environment in which a certain amount of propagation loss is expected, and
   when the first communication apparatus is situated in the environment, the processor does not perform processing of reducing the reduction amount for the first communication apparatus.
(17) The communication control apparatus according to any one of (1) to (16), in which
   the processor exchanges, with another communication control apparatus, the pieces of information regarding the priority relationships.
(18) The communication control apparatus according to any one of (2) to (17), in which
   a first operator has a right to preferentially secondarily use a spectrum in a first area and a second area,
   the first communication apparatus is a communication apparatus that is operated by the first operator in the first area, and
   the second communication apparatus is a communication apparatus that is operated by a second operator that has leased the right from the first operator in the second area.
(19) The communication control apparatus according to any one of (2) to (18), in which
   a first operator has a right to preferentially secondarily use a spectrum in a first area,
   a second operator has the right in a second area,
   the first communication apparatus is a communication apparatus that is operated by the first operator in the first area, or is a communication apparatus that is operated by a third operator that has leased the right from the first operator, and
   the second communication apparatus is a communication apparatus that is operated by the second operator in the second area, or is a communication apparatus that is operated by a fourth operator that has leased the right from the second operator.
(20) The communication control apparatus according to any one of (2) to (19), in which
   a first operator has a right to preferentially secondarily use a spectrum in a first area, and
   the first communication apparatus and the second communication apparatus are communication apparatuses that are respectively operated by operators of a plurality of operators each having leased the right from the first operator in the first area.
(21) The communication control apparatus according to any one of (2) to (20), in which
   a first operator has a right to preferentially secondarily use a spectrum in a first area, and
   the first communication apparatus and the second communication apparatus are communication apparatuses that are operated by the first operator in the first area.
(22) The communication control apparatus according to any one of (1) to (21), in which
   the processor
      groups a plurality of communication apparatuses to generate groups of the plurality of communication apparatuses having the priority relationship with each other, and
   determines the allowed transmission powers of the plurality of communication apparatuses for each group on the basis of the priority relationship.
(23) A communication control method, including:
   acquiring information indicating a priority relationship in interference protection between a first communication apparatus and a second communication apparatus that each transmit radio waves;
   determining an amount of a reduction in a transmission power of the first communication apparatus on the basis of the information indicating the priority relationship and an allowed interference power of the second communication apparatus; and
   determining an allowed transmission power of the first communication apparatus on the basis of the reduction amount.

### REFERENCE SIGNS LIST

11 receiver
12 processor
13 controller
14 transmitter
15 storage
31 receiver
32 processor
33 controller
34 transmitter
35 storage
110, 110A, 110B, 110C communication apparatus
120 terminal
130, 130A, 130B communication control apparatus

1. A communication control apparatus, comprising
a processor
that acquires information indicating a priority relationship in interference protection between a first communication apparatus and a second communication apparatus that each transmit radio waves,
that determines an amount of a reduction in a transmission power of the first communication apparatus on a basis of the information indicating the priority relationship and an allowed interference power of the second communication apparatus, and
that determines an allowed transmission power of the first communication apparatus on a basis of the reduction amount.

2. The communication control apparatus according to claim 1, wherein
when the first communication apparatus has a level of priority higher than a level of priority of the second communication apparatus, the processor reduces the reduction amount, compared to when the first communication apparatus has a level of priority lower than or equal to the level of priority of the second communication apparatus.

3. The communication control apparatus according to claim 2, wherein
when the first communication apparatus has a level of priority higher than the level of priority of the second communication apparatus, the processor sets the reduction amount to zero.

4. The communication control apparatus according to claim 3, wherein
the processor
distributes the allowed interference power of the second communication apparatus to at least one third communication apparatus,
determines an allowed transmission power of the third communication apparatus on a basis of the allowed interference power distributed to the third communication apparatus, and
does not distribute the allowed interference power of the second communication apparatus to the first communication apparatus, and
the third communication apparatus is a communication apparatus for which the priority relationship with the first communication apparatus and the second communication apparatus is not set, or
the third communication apparatus is a communication apparatus for which the priority relationship with the first communication apparatus and the second communication apparatus is set, and that has a level of priority lower than or equal to the level of priority of the second communication apparatus.

5. The communication control apparatus according to claim 2, wherein
the processor
subtracts, from the allowed interference power of the second communication apparatus, an interference budget that indicates an amount of interference with the second communication apparatus that is performed when the first communication apparatus transmits the radio waves with the transmission power,
distributes an allowed interference power obtained by the subtraction to a third communication apparatus, and
determines an allowed transmission power of the third communication apparatus on a basis of the allowed interference power distributed to the third communication apparatus, and
the third communication apparatus is a communication apparatus for which the priority relationship with the first communication apparatus and the second communication apparatus is not set, or
the third communication apparatus is a communication apparatus for which the priority relationship with the first communication apparatus and the second communication apparatus is set, and that has a level of priority lower than or equal to the level of priority of the second communication apparatus.

6. The communication control apparatus according to claim 5, wherein
the processor determines the transmission power of the first communication apparatus on a basis of an allowed interference power of an optional protection target, and
the interference budget indicates an amount of interference with the second communication apparatus that is performed when the first communication apparatus transmits the radio waves with the determined transmission power.

7. The communication control apparatus according to claim 6, wherein
the protection target includes at least one of a primary system or the third communication apparatus, the primary system preferentially using the radio waves over the first communication apparatus and the second communication apparatus.

8. The communication control apparatus according to claim 2, wherein
each of the first communication apparatus and the second communication apparatus transmits the radio waves on a basis of a certain right to preferentially secondarily use a spectrum,
the processor
subtracts, from the allowed interference power of the second communication apparatus, an interference budget that indicates an amount of interference with the second communication apparatus that is performed when the first communication apparatus transmits the radio waves with the transmission power, and
distributes an allowed interference power obtained by the subtraction to a fourth communication apparatus, and
the fourth communication apparatus is a communication apparatus that transmits the radio waves on a basis of another right to secondarily use the spectrum, the other right being given lesser priority than the certain right.

9. The communication control apparatus according to claim 2, wherein
the processor
distributes the allowed interference power of the second communication apparatus at least to the first communication apparatus,
determines the amount of the reduction in the transmission power of the first communication apparatus according to the allowed interference power distributed to the first communication apparatus, and according to an interference budget that indicates an amount of interference with the second communication apparatus that is performed when the first communication apparatus transmits the radio waves with the transmission power,
adjusts the reduction amount by reducing the reduction amount by an optional value, and
determines the allowed transmission power of the first communication apparatus on a basis of a reduction amount obtained by the adjustment.

10. The communication control apparatus according to claim 9, wherein
the processor determines the optional value according to a distance between the first communication apparatus and the second communication apparatus.

11. The communication control apparatus according to claim 2, wherein
the processor
determines the allowed transmission power of the first communication apparatus using a preset fixed value as the amount of the reduction in the transmission power of the first communication apparatus, or
determines the allowed transmission power of the first communication apparatus using the preset fixed value as a transmission power obtained by reducing the transmission power of the first communication apparatus by the low power amount.

12. The communication control apparatus according to claim 1, wherein
the processor
determines the transmission power of the first communication apparatus and the transmission power of the second communication apparatus by distributing an allowed interference power of an optional protection target to the first communication apparatus and the second communication apparatus in a first proportion, and
determines the first proportion according to the priority relationship between the first communication apparatus and the second communication apparatus.

13. The communication control apparatus according to claim 12, wherein
the priority relationship indicates that one of the first communication apparatus and the second communication apparatus has priority over another of the first communication apparatus and the second communication apparatus, and
the processor causes a larger portion of the allowed interference power to be distributed to the one of the first communication apparatus and the second communication apparatus than the other of the first communication apparatus and the second communication apparatus.

14. The communication control apparatus according to claim 2, wherein
the processor determines the reduction amount for the one of the first communication apparatus and the second communication apparatus by causing a propagation loss to apparently become larger, the propagation loss being a loss in propagation from the one of the first communication apparatus and the second communication apparatus to the other of the first communication apparatus and the second communication apparatus.

15. The communication control apparatus according to claim 13, wherein
the first communication apparatus is a communication apparatus that is operated by a first operator that has a right to preferentially secondarily use a spectrum, and
the second communication apparatus is a communication apparatus that is operated by a second operator that has leased the right from the first operator.

16. The communication control apparatus according to claim 2, wherein
the processor determines whether the first communication apparatus is situated in an environment in which a certain amount of propagation loss is expected, and
when the first communication apparatus is situated in the environment, the processor does not perform processing of reducing the reduction amount for the first communication apparatus.

17. The communication control apparatus according to claim 1, wherein
the processor exchanges, with another communication control apparatus, the pieces of information regarding the priority relationships.

18. The communication control apparatus according to claim 2, wherein
a first operator has a right to preferentially secondarily use a spectrum in a first area and a second area,
the first communication apparatus is a communication apparatus that is operated by the first operator in the first area, and
the second communication apparatus is a communication apparatus that is operated by a second operator that has leased the right from the first operator in the second area.

19. The communication control apparatus according to claim 2, wherein
a first operator has a right to preferentially secondarily use a spectrum in a first area,
a second operator has the right in a second area,
the first communication apparatus is a communication apparatus that is operated by the first operator in the first area, or is a communication apparatus that is operated by a third operator that has leased the right from the first operator, and
the second communication apparatus is a communication apparatus that is operated by the second operator in the second area, or is a communication apparatus that is operated by a fourth operator that has leased the right from the second operator.

20. The communication control apparatus according to claim 2, wherein
a first operator has a right to preferentially secondarily use a spectrum in a first area, and
the first communication apparatus and the second communication apparatus are communication apparatuses that are respectively operated by operators of a plurality of operators each having leased the right from the first operator in the first area.

21. The communication control apparatus according to claim 2, wherein
a first operator has a right to preferentially secondarily use a spectrum in a first area, and
the first communication apparatus and the second communication apparatus are communication apparatuses that are operated by the first operator in the first area.

22. The communication control apparatus according to claim 1, wherein
the processor
groups a plurality of communication apparatuses to generate groups of the plurality of communication apparatuses having the priority relationship with each other, and
determines the allowed transmission powers of the plurality of communication apparatuses for each group on a basis of the priority relationship.

23. A communication control method, comprising:
acquiring information indicating a priority relationship in interference protection between a first communication apparatus and a second communication apparatus that each transmit radio waves;
determining an amount of a reduction in a transmission power of the first communication apparatus on a basis of the information indicating the priority relationship and an allowed interference power of the second communication apparatus; and
determining an allowed transmission power of the first communication apparatus on a basis of the reduction amount.
